(19) United States
(12) Patent Application Publication
(10) Pub. No.: US 2021/0188172 A1
(43) Pub. Date: Jun. 24, 2021

(54) SIDE MIRROR FOR VEHICLES AND VEHICLE

(71) Applicant: LG Electronics Inc., Seoul (KR)

(72) Inventors: Kihoon HAN, Seoul (KR); Daebum KIM, Seoul (KR); Hyukmin EUM, Seoul (KR); Vassily KUZNETSOV, Seoul (KR)

(21) Appl. No.: 16/500,652

(22) PCT Filed: Aug. 7, 2018
(86) PCT No.: PCT/KR2018/008993

§ 371 Date: Oct. 3, 2019

(30) Foreign Application Priority Data
Aug. 8, 2017 (KR) 10-2017-0100529

(51) Int. Cl. B60R 1/062; B60W 30/095; B60W 30/09

(52) U.S. Cl. CPC B60R 1/062; B60W 30/0956; B60W 2554/80; B60W 30/0953; B60W 30/09

(57) ABSTRACT

Disclosed is a side mirror including a mirror configured to be bendable, a bending driver configured to bend the mirror, an interface configured to receive information about the situation around a vehicle, and a processor configured to control the bending driver based on the surrounding situation information in order to bend the mirror.

### TECHNICAL FIELD

The present disclosure relates to a side mirror for vehicles. More particularly, the present disclosure relates to a side mirror configured such that a mirror is bent depending on the situation around a vehicle, whereby an area necessary for a driver is reflected on the mirror.

### BACKGROUND ART

A vehicle is an apparatus that moves a passenger in a direction in which the passenger wishes to go. A representative example of the vehicle is a car.

Meanwhile, a vehicle has been equipped with various sensors and electronic devices for convenience of users who use the vehicle. In particular, research on an advanced driver assistance system (ADAS) has been actively conducted for convenience in driving of the user. Furthermore, research and development on a traveling system for vehicles enabling autonomous traveling of a vehicle has been actively conducted.

A side mirror for vehicles is configured such that an area located at the side rear of a vehicle is reflected on a mirror. A driver can see the area located at the side rear of the vehicle through the side mirror.

The mirror may be made of a bendable material. In the case in which the bendable mirror is bent, the size of an area reflected on the mirror may be changed. Consequently, a user may bend the mirror in order to see a wider area or to see a narrow area in the state of being enlarged.

A conventional side mirror has a problem in that the area capable of being seen using the mirror is limited.

In recent years, research has been conducted on a side mirror including a bendable mirror, wherein the mirror of the side mirror is configured to be appropriately bent in response to the situation around a vehicle.

### DISCLOSURE

### Technical Problem

The present disclosure has been made in view of the above problems, and it is an object of the present disclosure to provide a side mirror for vehicles including a mirror capable of being bent in response to the situation around a vehicle.

It is another object of the present disclosure to provide a side mirror for vehicles configured such that the direction in which a mirror is bent or the extent to which the mirror is bent is changed in response to the situation around a vehicle.

The objects of the present disclosure are not limited to the above-mentioned object, and other objects that have not been mentioned above will become evident to those skilled in the art from the following description.

### Technical Solution

In accordance with the present disclosure, the above objects can be accomplished by the provision of a side mirror including a mirror configured to be bendable, a bending driver configured to bend the mirror, an interface configured to receive information about the situation around a vehicle, and a processor configured to control the bending driver based on the surrounding situation information in order to bend the mirror.

The processor may set at least one of the direction in which the mirror is bent, the curvature of the mirror, and the speed at which the mirror is bent based on the surrounding situation information.

The details of other embodiments are included in the following description and the accompanying drawings.

### Advantageous Effects

According to embodiments of the present disclosure, one or more of the following effects are provided.

First, it is possible to bend a mirror such that a driver of a vehicle can see an area that cannot be seen through a conventional side mirror, whereby it is possible to improve driver convenience and traveling safety.

Second, it is possible to change the direction in which the mirror is bent, the curvature of the mirror, and the speed at which the mirror is bent depending on circumstances, whereby it is possible to provide the optimal visual field to the user while further improving convenience and safety.

It should be noted that effects of the present disclosure are not limited to the effects of the present disclosure as mentioned above, and other unmentioned effects of the present disclosure will be clearly understood by those skilled in the art from the following claims.

### DESCRIPTION OF DRAWINGS

FIG. 1 is a view showing the external appearance of a vehicle according to an embodiment of the present disclosure.

FIG. 2 is a view showing the exterior of the vehicle according to the embodiment of the present disclosure when viewed at various angles.

FIGS. 3 and 4 are views showing the interior of the vehicle according to the embodiment of the present disclosure.

FIGS. 5 and 6 are reference views illustrating an object according to an embodiment of the present disclosure.

FIG. 7 is a reference block diagram illustrating the vehicle according to the embodiment of the present disclosure.

FIG. 8 is a block diagram illustrating the structure of a side mirror for vehicles according to an embodiment of the present disclosure.

FIGS. 9 to 11 are views illustrating a mode in which a mirror of the side mirror for vehicles according to the embodiment of the present disclosure is bent.

FIG. 12 is a flowchart illustrating the operation of the side mirror for vehicles according to the embodiment of the present disclosure.

FIGS. 13 and 14 are views illustrating that the mirror of the side mirror for vehicles according to the embodiment of the present disclosure is bent based on an object.

FIGS. 15 and 16 are views illustrating that the mirror of the side mirror for vehicles according to the embodiment of the present disclosure is bent based on vehicle steering input.

FIGS. 17 and 18 are views illustrating that the mirror of the side mirror for vehicles according to the embodiment of the present disclosure is bent based on the shape of a traveling section.

FIGS. 19 and 20 are views illustrating that the mirror of the side mirror for vehicles according to the embodiment of the present disclosure is bent based on a predetermined event.

FIGS. 21 to 24 are views illustrating that the mirror of the side mirror for vehicles according to the embodiment of the present disclosure is tilted based on the environment around a vehicle.

### BEST MODE

Hereinafter, the embodiments disclosed in the present specification will be described in detail with reference to the accompanying drawings, and the same or similar elements are denoted by the same reference numerals even though they are depicted in different drawings and redundant descriptions thereof will be omitted. In the following description, with respect to constituent elements used in the following description, the suffixes “module” and “unit” are used or combined with each other only in consideration of ease in the preparation of the specification, and do not have or serve different meanings. Also, in the following description of the embodiments disclosed in the present specification, a detailed description of known functions and configurations incorporated herein will be omitted when it may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents and substitutions included in the scope and sprit of the present disclosure.

It will be understood that, although the terms “first,” “second,” etc., may be used herein to describe various components, these components should not be limited by these terms. These terms are only used to distinguish one component from another component.

It will be understood that, when a component is referred to as being “connected to” or “coupled to” another component, it may be directly connected to or coupled to another component or intervening components may be present. In contrast, when a component is referred to as being “directly connected to” or “directly coupled to” another component, there are no intervening components present.

As used herein, the singular form is intended to include the plural forms as well, unless the context clearly indicates otherwise.

In the present application, it will be further understood that the terms “comprises,” “includes,” etc. specify the presence of stated features, integers, steps, operations, elements, components, or combinations thereof, but do not preclude the presence or addition of one or more other features, integers, steps, operations, elements, components, or combinations thereof.

A vehicle as described in this specification may be a concept including a car and a motorcycle. Hereinafter, a car will be described as an example of the vehicle.

A vehicle as described in this specification may include all of an internal combustion engine vehicle including an engine as a power source, a hybrid vehicle including both an engine and an electric motor as a power source, and an electric vehicle including an electric motor as a power source.

“The left side of the vehicle” refers to the left side in the traveling direction of the vehicle, and “the right side of the vehicle” refers to the right side in the traveling direction of the vehicle.

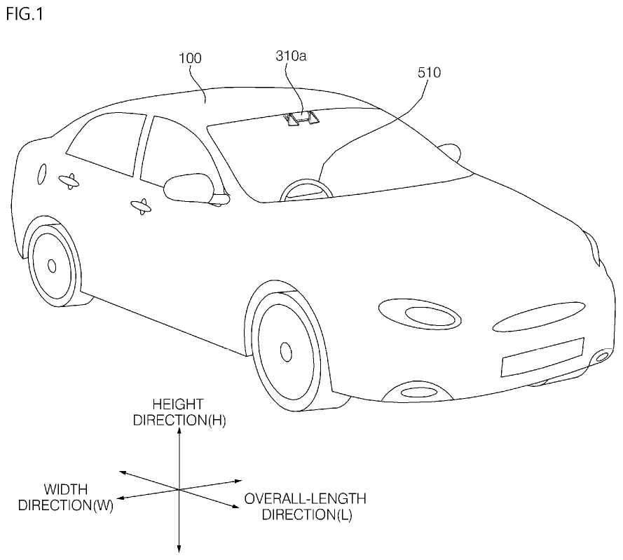

FIGS. 1 to 7 are views illustrating a vehicle according to the present disclosure. Hereinafter, the vehicle according to the present disclosure will be described with reference to FIGS. 1 to 7.

FIG. 1 is a view showing the external appearance of a vehicle according to an embodiment of the present disclosure.

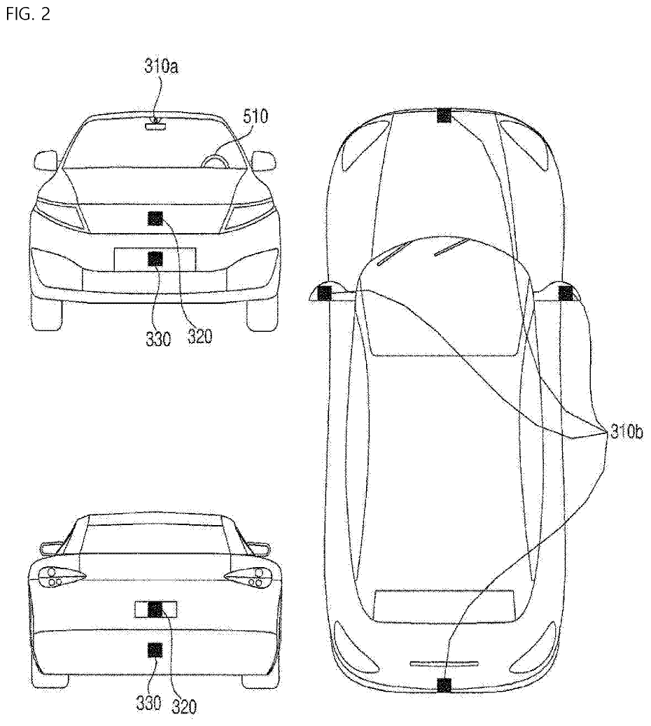

FIG. 2 is a view showing the exterior of the vehicle according to the embodiment of the present disclosure when viewed at various angles.

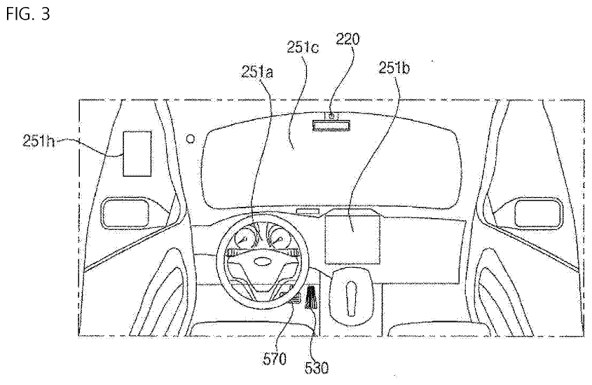

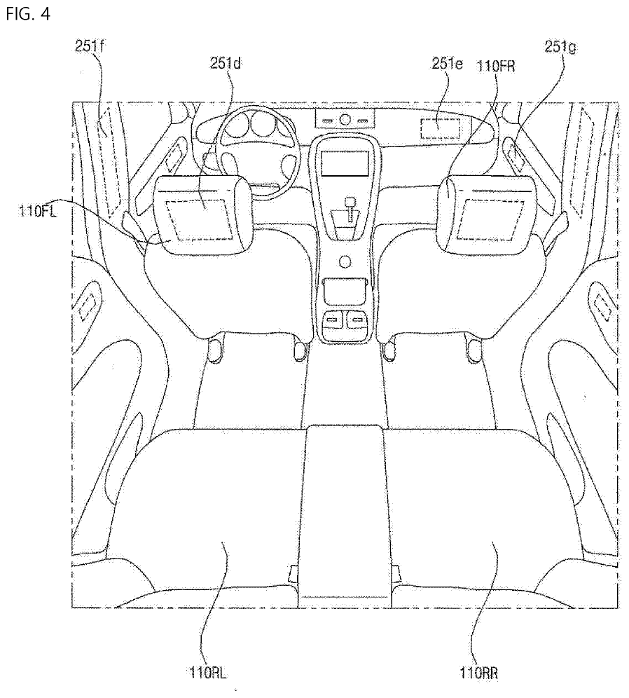

FIGS. 3 and 4 are views showing the interior of the vehicle according to the embodiment of the present disclosure.

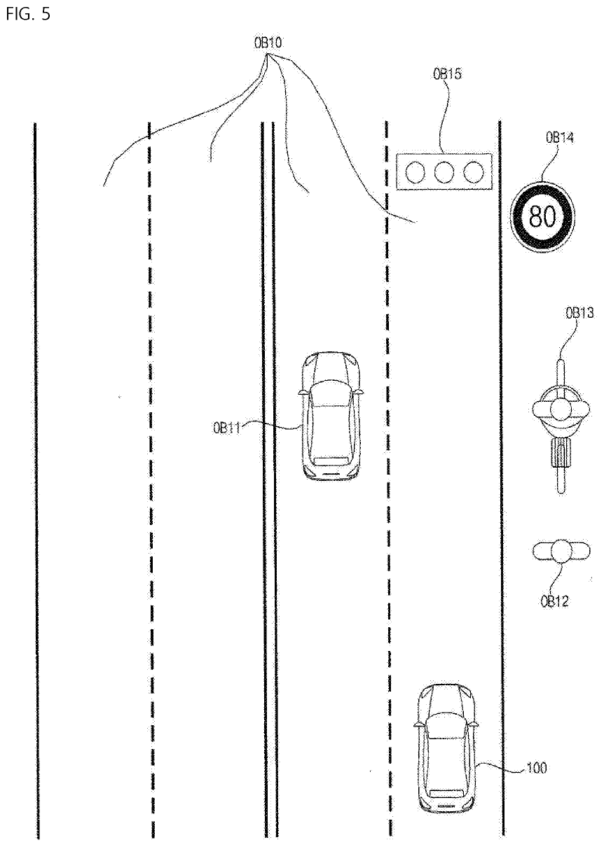

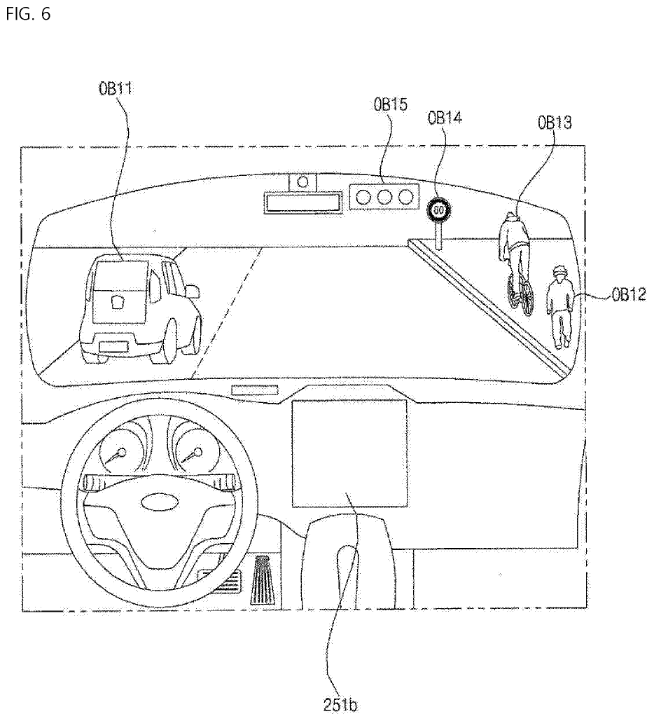

FIGS. 5 and 6 are reference views illustrating an object according to an embodiment of the present disclosure.

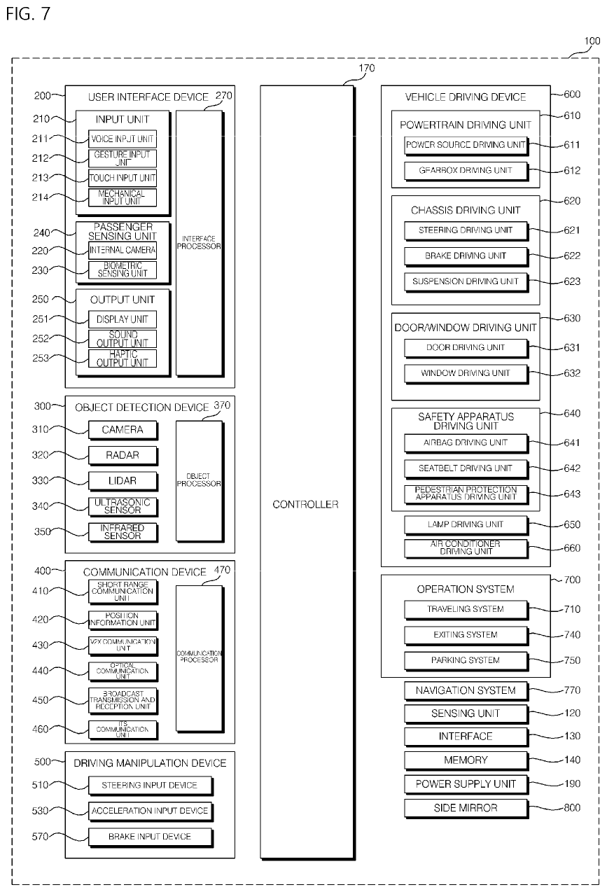

FIG. 7 is a reference block diagram illustrating the vehicle according to the embodiment of the present disclosure.

Referring to FIGS. 1 to 7, the vehicle 100 may include wheels configured to be rotated by a power source and a steering input device 510 configured to adjust the advancing direction of the vehicle 100.

The vehicle 100 may include various advanced driver assistance systems. Each advanced driver assistance system is a system that assists a driver based on information acquired by various sensors. The advanced driver assistance system may be simply referred to as an ADAS.

The vehicle 100 may include various lighting devices for vehicles. The lighting devices for vehicles may include a head lamp, a rear combination lamp, a turn signal lamp, and a room lamp. The rear combination lamp includes a brake lamp and a tail lamp.

The vehicle 100 may include an internal sensing device and an external sensing device.

“Overall length” means the length from the front end to the rear end of the vehicle, “width” means the width of the vehicle 100, and “height” means the length from the lower end of each wheel to a roof of the vehicle 100. In the following description, “overall-length direction L” may mean a direction based on which the overall length of the vehicle 100 is measured, “width direction W” may mean a direction based on which the width of the vehicle 100 is measured, and “height direction H” may mean a direction based on which the height of the vehicle 100 is measured.

The vehicle 100 may be an autonomous vehicle. The vehicle 100 may autonomously travel under the control of a controller 170. The vehicle 100 may autonomously travel based on vehicle traveling information.

The vehicle traveling information is information acquired or provided by various units provided in the vehicle 100. The vehicle traveling information may be information utilized for the controller 170 or an operation system 700 to control the vehicle 100.

The vehicle traveling information may be classified into surrounding situation information related to the situation around the vehicle 100, vehicle state information related to the state of various devices provided in the vehicle 100, and passenger information related to a passenger in the vehicle 100 depending on contents to which the information is related. Consequently, the vehicle traveling information may include at least one of the surrounding situation information, the vehicle state information, or the passenger information.

The vehicle traveling information may be classified into object information acquired by an object detection device 300, communication information that a communication device 400 receives from an external communication device, user input received by a user interface device 200 or a driving manipulation device 500, navigation information provided by a navigation system 770, various kinds of sensing information provided by a sensing unit 120, and storage information stored in a memory 140 depending on devices that provide information. Consequently, the vehicle traveling information may include at least one of the object information, the communication information, the user input, the navigation information, the sensing information, information acquired and provided by an interface 130, or the storage information.

The vehicle traveling information may be acquired through at least one of the user interface device 200, the object detection device 300, the communication device 400, the driving manipulation device 500, the navigation system 770, the sensing unit 120, the interface 130, or the memory 140, and may be provided to the controller 170 or the operation system 700. The controller 170 or the operation system 700 may perform control such that the vehicle 100 autonomously travels based on the vehicle traveling information.

The object information is information about an object sensed by the object detection device 300. For example, the object information may be information about the shape, position, size, and color of an object. For example, the object information may be information about a lane, an image marked on the surface of a road, an obstacle, another vehicle, a pedestrian, a signal light, various kinds of bodies, and a traffic sign.

The communication information may be information transmitted by an external device capable of performing communication. For example, the communication information may include at least one of information transmitted by another vehicle, information transmitted by a mobile terminal, information transmitted by traffic infrastructure, or information present on a specific network. The traffic infrastructure may include a signal light, and the signal light may transmit information about a traffic signal.

In addition, the vehicle traveling information may include at least one of information about the state of various devices provided in the vehicle 100 or information about the position of the vehicle 100. For example, the vehicle traveling information may include information about errors of various devices provided in the vehicle 100, information about the operation state of various devices provided in the vehicle 100, information about a traveling lane of the vehicle 100, and map information.

For example, the controller 170 or the operation system 700 may determine the kind, position, and movement of an object present around the vehicle 100 based on the vehicle traveling information. The controller 170 or the operation system 700 may determine the possibility of collision between the vehicle and an object, the kind of a road on which the vehicle 100 travels, a traffic signal around the vehicle 100, and the movement of the vehicle 100 based on the vehicle traveling information.

Information about the environment or situation around the vehicle, which is an example of the vehicle traveling information, may be referred to as surrounding environment information or surrounding situation information. For example, object information acquired by the object detection device 300 is information corresponding to the surrounding situation information. For example, information about a traveling section on which the vehicle 100 travels, traffic status, and another vehicle, which is an example of the communication information that the communication device 400 receives from an external communication device, is information corresponding to the surrounding situation information. For example, the map information or the information about the position of the vehicle 100, which is an example of the navigation information provided by the navigation system 770, is information corresponding to the surrounding situation information.

The passenger information is information about a passenger in the vehicle 100. The information related to the passenger in the vehicle 100, which is an example of the vehicle traveling information, may be referred to as passenger information.

The passenger information may be acquired through an internal camera 220 or a biometric sensing unit 230. In this case, the passenger information may include at least one of an image of the passenger in the vehicle 100 or biometric information of the passenger.

For example, the passenger information may be an image of the passenger acquired through the internal camera 220. For example, the biometric information may be information about the temperature, pulse, and brain waves of the passenger acquired through the biometric sensing unit 230.

For example, the controller 170 may determine the location, shape, gaze, face, action, expression, drowsiness, health, and emotion of the passenger based on the passenger information.

In addition, the passenger information may be information that is transmitted by a mobile terminal of the passenger and is received by the communication device 400. For example, the passenger information may be authentication information for authenticating the passenger.

The passenger information may be acquired by a passenger sensing unit 240 or the communication device 400, and may be provided to the controller 170. The passenger information may be a concept included in the vehicle traveling information.

The vehicle state information may be information related to the state of various units provided in the vehicle 100. Information related to the state of the units of the vehicle 100, which is an example of the vehicle traveling information, may be referred to as vehicle state information.

For example, the vehicle state information may include information about the operation state and errors of the user interface device 200, the object detection device 300, the communication device 400, the driving manipulation device 500, the vehicle driving device 600, the operation system 700, the navigation system 770, the sensing unit 120, the interface 130, and the memory 140.

The controller 170 may determine operations and errors of various units provided in the vehicle 100 based on the vehicle state information. For example, the controller 170 may determine whether a GPS signal of the vehicle 100 is normally received, whether at least one sensor provided in the vehicle 100 malfunctions, and whether each device provided in the vehicle 100 is normally operated based on the vehicle state information.

The vehicle state information may be a concept included in the vehicle traveling information.

A control mode of the vehicle 100 may be a mode indicating a subject that controls the vehicle 100.

For example, the control mode of the vehicle 100 may include an autonomous mode, in which the controller 170 or the operation system 700 included in the vehicle 100 controls the vehicle 100, a manual mode, in which a driver in the vehicle 100 controls the vehicle 100, and a remote control mode, in which a device other than the vehicle 100 controls the vehicle 100.

In the autonomous mode, the controller 170 or the operation system 700 may control the vehicle 100 based on the vehicle traveling information. Consequently, the vehicle 100 may be operated without a user command through the driving manipulation device 500. For example, in the autonomous mode, the vehicle 100 may be operated based on information, data, or a signal generated by a traveling system 710, an exiting system 740, and a parking system 750.

In the manual mode, the vehicle 100 may be controlled according to a user command for at least one of steering, acceleration, or deceleration received through the driving manipulation device 500. In this case, the driving manipulation device 500 may generate an input signal corresponding to the user command, and may provide the same to the controller 170. The controller 170 may control the vehicle 100 based on the input signal provided by the driving manipulation device 500.

In the remote control mode, a device other than the vehicle 100 may control the vehicle 100. In the case in which the vehicle 100 is operated in the remote control mode, the vehicle 100 may receive a remote control signal transmitted by another device through the communication device 400. The vehicle 100 may be controlled based on the remote control signal.

The vehicle 100 may enter one of the autonomous mode, the manual mode, and the remote control mode based on user input received through the user interface device 200.

The control mode of the vehicle 100 may switch to one of the autonomous mode, the manual mode, and the remote control mode based on the vehicle traveling information. For example, the control mode of the vehicle 100 may switch from the manual mode to the autonomous mode or from the autonomous mode to the manual mode based on object information generated by the object detection device 300. The control mode of the vehicle 100 may switch from the manual mode to the autonomous mode or from the autonomous mode to the manual mode based on information received through the communication device 400.

As exemplarily shown in FIG. 7, the vehicle 100 may include a user interface device 200, an object detection device 300, a communication device 400, a driving manipulation device 500, a vehicle driving device 600, an operation system 700, a navigation system 770, a sensing unit 120, an interface 130, a memory 140, a controller 170, and a power supply unit 190.

In some embodiments, the vehicle 100 may further include components other than the components that are described in this specification, or may not include some of the components that are described herein.

The user interface device 200 is a device for communication between the vehicle 100 and a user. The user interface device 200 may receive user input and may provide information generated by the vehicle 100 to the user. The vehicle 100 may realize a user interface (UI) or a user experience (UX) through the user interface device 200.

The user interface device 200 may include an input unit 210, an internal camera 220, a biometric sensing unit 230, an output unit 250, and an interface processor 270.

In some embodiments, the user interface device 200 may further include components other than the components that are described herein, or may not include some of the components that are described herein.

The input unit 210 is configured to receive a user command from the user. Data collected by the input unit 210 may be analyzed by the interface processor 270 and may be recognized as a control command of the user.

The input unit 210 may be disposed in the vehicle. For example, the input unit 210 may be disposed in a portion of a steering wheel, a portion of an instrument panel, a portion of a seat, a portion of each pillar, a portion of a door, a portion of a center console, a portion of a head lining, a portion of a sun visor, a portion of a windshield, or a portion of a window.

The input unit 210 may include a voice input unit 211, a gesture input unit 212, a touch input unit 213, and a mechanical input unit 214.

The voice input unit 211 may convert the user voice input into an electrical signal. The converted electrical signal may be provided to the interface processor 270 or the controller 170.

The voice input unit 211 may include one or more microphones.

The gesture input unit 212 may convert user gesture input into an electrical signal. The converted electrical signal may be provided to the interface processor 270 or the controller 170.

The gesture input unit 212 may include at least one of an infrared sensor or an image sensor for sensing user gesture input.

In some embodiments, the gesture input unit 212 may sense three-dimensional user gesture input. To this end, the gesture input unit 212 may include a light output unit for outputting a plurality of infrared beams or a plurality of image sensors.

The gesture input unit 212 may sense the three-dimensional user gesture input through a time of flight (TOF) scheme, a structured light scheme, or a disparity scheme.

The touch input unit 213 may convert user touch input into an electrical signal. The converted electrical signal may be provided to the interface processor 270 or the controller 170.

The touch input unit 213 may include a touch sensor for sensing user touch input.

In some embodiments, the touch input unit 213 may be integrated into a display unit 251 in order to realize a touchscreen. The touchscreen may provide both an input interface and an output interface between the vehicle 100 and the user.

The mechanical input unit 214 may include at least one of a button, a dome switch, a jog wheel, or a jog switch. An electrical signal generated by the mechanical input unit 214 may be provided to the interface processor 270 or the controller 170.

The mechanical input unit 214 may be disposed in a steering wheel, a center fascia, a center console, a cockpit module, a door, etc.

The passenger sensing unit 240 may sense a passenger in the vehicle 100. The passenger sensing unit 240 may include an internal camera 220 and a biometric sensing unit 230.

The internal camera 220 may acquire an image inside the vehicle. The interface processor 270 may sense the state of the user based on the image inside the vehicle. For example, the state of the user that is sensed may be the gaze, face, action, expression, and location of a user.

The interface processor 270 may determine the gaze, face, action, expression, and location of the user based on the image inside the vehicle acquired by the internal camera 220. The interface processor 270 may determine user gesture based on the image inside the vehicle. The result of determination of the interface processor 270 based on the image inside the vehicle may be referred to as passenger information. In this case, the passenger information may be information indicating the gaze direction, action, expression, and gesture of the user. The interface processor 270 may provide the passenger information to the controller 170.

The biometric sensing unit 230 may acquire biometric information of the user. The biometric sensing unit 230 may include a sensor capable of acquiring the biometric information of the user, and may acquire fingerprint information, heart rate information, brain wave information, etc. of the user using the sensor. The biometric information may be used to authenticate the user or to determine the state of the user.

The interface processor 270 may determine the state of the user based on the biometric information of the user acquired by the biometric sensing unit 230. The state of the user determined by the interface processor 270 may be referred to as passenger information. In this case, the passenger information is information indicating whether the user has fainted, is dozing, is excited, or is in critical condition. The interface processor 270 may provide the passenger information to the controller 170.

The output unit 250 is configured to generate output related to visual sensation, aural sensation, or tactile sensation.

The output unit 250 may include at least one of a display unit 251, a sound output unit 252, or a haptic output unit 253.

The display unit 251 may display a graphical object corresponding to various kinds of information.

The display unit 251 may include at least one of a liquid crystal display (LCD), a thin film transistor-liquid crystal display (TFT LCD), an organic light-emitting diode (OLED), a flexible display, a 3D display, or an e-ink display.

The display unit 251 may be connected to the touch input unit 213 in a layered structure, or may be formed integrally with the touch input unit, so as to realize a touchscreen.

The display unit 251 may be realized as a head-up display (HUD). In the case in which the display unit 251 is realized as the HUD, the display unit 251 may include a projection module in order to output information through an image projected on the windshield or the window.

The display unit 251 may include a transparent display. The transparent display may be attached to the windshield or the window.

The transparent display may display a predetermined screen while having predetermined transparency. In order to have transparency, the transparent display may include at least one of a transparent thin film electroluminescent (TFEL) display, a transparent organic light-emitting diode (OLED) display, a transparent Liquid Crystal Display (LCD), a transmissive type transparent display, or a transparent light emitting diode (LED) display. The transparency of the transparent display may be adjusted.

Meanwhile, the user interface device 200 may include a plurality of display units 251a to 251h.

The display unit 251 may be realized in a portion of the steering wheel, portions of the instrument panel (251a, 251b, and 251e), a portion of the seat (251d), a portion of each pillar (251f), a portion of the door (251g), a portion of the center console, a portion of the head lining, a portion of the sun visor, a portion of the windshield (251c), or a portion of the window (251h).

The sound output unit 252 converts an electrical signal provided from the interface processor 270 or the controller 170 into an audio signal, and outputs the converted audio signal. To this end, the sound output unit 252 may include one or more speakers.

The haptic output unit 253 may generate tactile output. For example, the tactile output is vibration. The haptic output unit 253 vibrated the steering wheel, a safety belt, and seats 110FL, 110FR, 110RL, and 110RR such that the user recognizes the output.

The interface processor 270 may control the overall operation of each unit of the user interface device 200.

In some embodiments, the user interface device 200 may include a plurality of interface processors 270, or may not include the interface processor 270.

In the case in which the interface processor 270 is not included in the user interface device 200, the user interface device 200 may be operated under the control of a processor of another device in the vehicle 100 or the controller 170.

Meanwhile, the user interface device 200 may be referred to as a multimedia device for vehicles.

The user interface device 200 may be operated under the control of the controller 170.

The object detection device 300 is a device that detects an object located outside the vehicle 100.

The object may be various bodies related to the operation of the vehicle 100.

Referring to FIGS. 5 and 6, the object 0 may include a lane OB10, a line that partitions lanes OB10 from each other, another vehicle OB11, a pedestrian OB12, a two-wheeled vehicle OB13, a traffic signal OB14 and OB15, a curbstone that partitions a lane and a sidewalk from each other, light, a road, a structure, a speed bump, a geographical body, and an animal.

The lane OB10 may be a traveling lane, a lane next to the traveling lane, or a lane in which an opposite vehicle travels. The lane OB10 may be a concept including left and right lines that define the lane.

The vehicle OB11 may be a vehicle that is traveling around the vehicle 100. The vehicle OB11 may be a vehicle located within a predetermined distance from the vehicle 100. For example, the vehicle OB11 may be a vehicle that precedes or follows the vehicle 100. For example, the vehicle OB11 may be a vehicle that travels beside the vehicle 100.

The pedestrian OB12 may be a person located around the vehicle 100. The pedestrian OB12 may be a person located within a predetermined distance from the vehicle 100. For example, the pedestrian OB12 may be a person located on a sidewalk or a roadway.

The two-wheeled vehicle OB13 may be a vehicle that is located around the vehicle 100 and is movable using two wheels. The two-wheeled vehicle OB13 may be a vehicle that is located within a predetermined distance from the vehicle 100 and has two wheels. For example, the two-wheeled vehicle OB13 may be a motorcycle or a bicycle located on a sidewalk or a roadway.

The traffic signal OB14 and OB15 may include a traffic light OB15, a traffic board OB14, and a pattern or text marked on the surface of a road.

The light may be light generated by a lamp of the vehicle OB11. The light may be light generated by a streetlight. The light may be sunlight.

The road may include a road surface, a curve, and a slope, such as an upward slope or a downward slope. The geographical body may include a mountain and a hill.

The structure may be a body that is located around a road and fixed to the ground. For example, the structure may include a streetlight, a roadside tree, a building, an electric pole, a signal light, a bridge, a curbstone, and a guardrail.

The object may be classified as a moving object or a stationary object. The moving object is an object that is movable. For example, the moving object may be a concept including another vehicle and a pedestrian. The stationary object is an object that is not movable. For example, the stationary object may be a concept including a traffic signal, a road, a structure, and a line.

The object detection device 300 may detect an obstacle present outside the vehicle 100. The obstacle may be one of a body, a pothole, the start point of an upward slope, the start point of a downward slope, an inspection pit, a speed bump, and a boundary stone. The body may be an object having volume and mass.

The object detection device 300 may include a camera 310, a radar 320, a lidar 330, an ultrasonic sensor 340, an infrared sensor 350, and a sensing processor 370.

In some embodiments, the object detection device 300 may further include components other than the components that are described herein, or may not include some of the components that are described herein.

The camera 310 may be located at an appropriate position outside the vehicle in order to acquire an image outside the vehicle. The camera 310 may provide the acquired image to the sensing processor 370. The camera 310 may be a mono camera, a stereo camera 310a, an around view monitoring (AVM) camera 310b, or a 360-degree camera.

For example, the camera 310 may be disposed in the vehicle so as to be adjacent to a front windshield in order to acquire an image ahead of the vehicle. Alternatively, the camera 310 may be disposed around a front bumper or a radiator grill.

For example, the camera 310 may be disposed in the vehicle so as to be adjacent to a rear glass in order to acquire an image behind the vehicle. Alternatively, the camera 310 may be disposed around a rear bumper, a trunk, or a tail gate.

For example, the camera 310 may be disposed in the vehicle so as to be adjacent to at least one of side windows in order to acquire an image beside the vehicle. Alternatively, the camera 310 may be disposed around a side mirror, a fender, or a door.

The radar (radio detection and ranging) 320 may include an electromagnetic wave transmission unit and an electromagnetic wave reception unit. The radar 320 may be realized using a pulse radar scheme or a continuous wave radar scheme based on an electric wave emission principle. In the continuous wave radar scheme, the radar 320 may be realized using a frequency modulated continuous wave (FMCW) scheme or a frequency shift keying (FSK) scheme based on a signal waveform.

The radar 320 may detect an object based on a time of flight (TOF) scheme or a phase-shift scheme through the medium of an electromagnetic wave, and may detect the position of the detected object, the distance from the detected object, and the speed relative to the detected object.

The radar 320 may be disposed at an appropriate position outside the vehicle in order to sense an object located ahead of, behind, or beside the vehicle.

The lidar (light detection and ranging) 330 may include a laser transmission unit and a laser reception unit. The lidar 330 may be realized using a time of flight (TOF) scheme or a phase-shift scheme.

The lidar 330 may be of a driving type or a non-driving type.

The driving type lidar 330 may be rotated by a motor in order to detect an object around the vehicle 100.

The non-driving type lidar 330 may detect an object located within a predetermined range from the vehicle 100 through light steering. The vehicle 100 may include a plurality of non-driving type lidars 330.

The lidar 330 may detect an object based on a time of flight (TOF) scheme or a phase-shift scheme through the medium of laser light, and may detect the position of the detected object, the distance from the detected object, and the speed relative to the detected object.

The lidar 330 may be disposed at an appropriate position outside the vehicle in order to sense an object located ahead of, behind, or beside the vehicle.

The ultrasonic sensor 340 may include an ultrasonic wave transmission unit and an ultrasonic wave reception unit. The ultrasonic sensor 340 may detect an object based on an ultrasonic wave, and may detect the position of the detected object, the distance from the detected object, and the speed relative to the detected object.

The ultrasonic sensor 340 may be disposed at an appropriate position outside the vehicle in order to sense an object located ahead of, behind, or beside the vehicle.

The infrared sensor 350 may include an infrared transmission unit and an infrared reception unit. The infrared sensor 350 may detect an object based on infrared light, and may detect the position of the detected object, the distance from the detected object, and the speed relative to the detected object.

The infrared sensor 350 may be disposed at an appropriate position outside the vehicle in order to sense an object located ahead of, behind, or beside the vehicle.

The sensing processor 370 may control the overall operation of each unit included in the object detection device 300.

The sensing processor 370 may detect and track an object based on an acquired image. The sensing processor 370 may calculate the distance from the object, may calculate the speed relative to the object, may determine the kind, position, size, shape, color, and movement route of the object, and determine the content of sensed text through an image processing algorithm.

The sensing processor 370 may detect and track an object based on a reflected electromagnetic wave returned as the result of a transmitted electromagnetic wave being reflected by the object. The sensing processor 370 may calculate the distance from the object and the speed relative to the object based on the electromagnetic wave.

The sensing processor 370 may detect and track an object based on reflected laser light returned as the result of transmitted laser light being reflected by the object. The sensing processor 370 may calculate the distance from the object and the speed relative to the object based on the laser light.

The sensing processor 370 may detect and track an object based on a reflected ultrasonic wave returned as the result of a transmitted ultrasonic wave being reflected by the object. The sensing processor 370 may calculate the distance from the object and the speed relative to the object based on the ultrasonic wave.

The sensing processor 370 may detect and track an object based on reflected infrared light returned as the result of transmitted infrared light being reflected by the object. The sensing processor 370 may calculate the distance from the object and the speed relative to the object based on the infrared light.

The sensing processor 370 may generate object information based on at least one of the image acquired through the camera 310, the reflected electromagnetic wave received through the radar 320, the reflected laser light received through the lidar 320, the reflected ultrasonic wave received through the ultrasonic sensor 340, or the reflected infrared light received through the infrared sensor 350.

The object information may be information about the kind, position, size, shape, color, movement route, and speed of an object present around the vehicle 100 and the content of sensed text.

For example, the object information may indicate whether a line is present around the vehicle 100, whether another vehicle around the vehicle 100 travels in the state in which the vehicle 100 is stopped, whether a stop zone is present around the vehicle 100, the possibility of collision between the vehicle and an object, how pedestrians or bicycles are distributed around the vehicle 100, the kind of a road on which the vehicle 100 travels, the state of a signal light around the vehicle 100, and the movement of the vehicle 100. The object information may be included in the vehicle traveling information.

The sensor processor 370 may provide the generated object information to the controller 170.

In some embodiments, the object detection device 300 may include a plurality of the processors 370, or may not include the sensing processor 370. For example, each of the camera 310, the radar 320, the lidar 330, the ultrasonic sensor 340, and the infrared sensor 350 may include a processor.

The object detection device 300 may be operated under the control of a processor of another device in the vehicle 100 or the controller 170.

The communication device 400 is a device for communication with an external device. Here, the external device may be one of another vehicle, a mobile terminal, a wearable device, and a server.

The communication device 400 may include at least one of a transmission antenna, a reception antenna, a radio frequency (RF) circuit capable of realizing various communication protocols, or an RF element in order to perform communication.

The communication device 400 may include a short range communication unit 410, a position information unit 420, a V2X communication unit 430, an optical communication unit 440, a broadcast transmission and reception unit 450, an intelligent transport system (ITS) communication unit 460, and a communication processor 470.

In some embodiments, the communication device 400 may further include components other than the components that are described herein, or may not include some of the components that are described herein.

The short range communication unit 410 is a unit for short range communication. The short range communication unit 410 may support short range communication using at least one of Bluetooth™, radio frequency identification (RFID), infrared data association (IrDA), ultra-wideband (UWB), ZigBee, near field communication (NFC), wireless-fidelity (Wi-Fi), Wi-Fi Direct, or wireless universal serial bus (Wireless USB) technology.

The short range communication unit 410 may form a short range wireless area network in order to perform short range communication between the vehicle 100 and at least one external device.

The position information unit 420 is a unit for acquiring position information of the vehicle 100. For example, the position information unit 420 may include at least one of a global positioning system (GPS) module, a differential global positioning system (DGPS) module, or a carrier phase differential GPS (CDGPS) module.

The position information unit 420 may acquire GPS information through the GPS module. The position information unit 420 may transmit the acquired GPS information to the controller 170 or the communication processor 470. The GPS information acquired by the position information unit 420 may be utilized during autonomous traveling of the vehicle 100. For example, the controller 170 may perform control such that the vehicle 100 autonomously travels based on the GPS information and navigation information acquired through the navigation system 770.

The V2X communication unit 430 is a unit for wireless communication with a server (V2I: Vehicle to Infrastructure), another vehicle (V2V: Vehicle to Vehicle), or a pedestrian (V2P: Vehicle to Pedestrian). The V2X communication unit 430 may include an RF circuit capable of realizing protocols for communication with infrastructure (V2I), communication between vehicles (V2V), and communication with a pedestrian (V2P).

The optical communication unit 440 is a unit for performing communication with an external device through the medium of light. The optical communication unit 440 may include an optical transmission unit for converting an electrical signal into an optical signal and transmitting the optical signal and an optical reception unit for converting a received optical signal into an electrical signal.

In some embodiments, the optical transmission unit may be integrated into a lamp included in the vehicle 100.

The broadcast transmission and reception unit 450 is a unit for receiving a broadcast signal from an external broadcasting administration server through a broadcasting channel or transmitting a broadcast signal to the broadcasting administration server. The broadcasting channel may include a satellite channel and a terrestrial channel. The broadcast signal may include a TV broadcast signal, a radio broadcast signal, and a data broadcast signal.

The ITS communication unit 460 communicates with a server that provides an intelligent transport system. The ITS communication unit 460 may receive information about various kinds of traffic status from the server that provides the intelligent transport system. The information about traffic status may include information about traffic congestion, traffic status by road, and traffic volume by section.

The communication processor 470 may control the overall operation of each unit of the communication device 400.

The vehicle traveling information may include information received through at least one of the short range communication unit 410, the position information unit 420, the V2X communication unit 430, the optical communication unit 440, the broadcast transmission and reception unit 450, or the ITS communication unit 460.

For example, the vehicle traveling information may include information about the position, type, traveling lane, speed, and various sensing values of another vehicle received therefrom. In the case in which information about various sensing values of the other vehicle is received through the communication device 400, the controller 170 may acquire information about various objects present around the vehicle 100 even though no separate sensor is provided in the vehicle 100.

For example, the vehicle traveling information may indicate the kind, position, and movement of an object present around the vehicle 100, whether a line is present around the vehicle 100, whether another vehicle around the vehicle 100 travels in the state in which the vehicle 100 is stopped, whether a stop zone is present around the vehicle 100, the possibility of collision between the vehicle and an object, how pedestrians or bicycles are distributed around the vehicle 100, the kind of a road on which the vehicle 100 travels, the state of a signal light around the vehicle 100, and the movement of the vehicle 100.

In some embodiments, the communication device 400 may include a plurality of communication processors 470, or may not include the communication processor 470.

In the case in which the communication processor 470 is not included in the communication device 400, the communication device 400 may be operated under the control of a processor of another device in the vehicle 100 or the controller 170.

Meanwhile, the communication device 400 may realize a multimedia device for vehicles together with the user interface device 200. In this case, the multimedia device for vehicles may be referred to as a telematics device or an audio video navigation (AVN) device.

The communication device 400 may be operated under the control of the controller 170.

The driving manipulation device 500 is a device that receives a user command for driving.

In the manual mode, the vehicle 100 may be operated based on a signal provided by the driving manipulation device 500.

The driving manipulation device 500 may include a steering input device 510, an acceleration input device 530, and a brake input device 570.

The steering input device 510 may receive a user command for steering the vehicle 100. The user command for steering may be a command corresponding to a specific steering angle. For example, the user command for steering may correspond to right 45 degrees.

The steering input device 510 may be configured in the form of a wheel, which is rotated for steering input. In this case, the steering input device 510 may be referred to as a steering wheel or a handle.

In some embodiments, the steering input device 510 may be configured in the form of a touchscreen, a touch pad, or a button.

The acceleration input device 530 may receive a user command for acceleration of the vehicle 100.

The brake input device 570 may receive a user command for deceleration of the vehicle 100. Each of the acceleration input device 530 and the brake input device 570 may be configured in the form of a pedal.

In some embodiments, the acceleration input device or the brake input device may be configured in the form of a touchscreen, a touch pad, or a button.

The driving manipulation device 500 may be operated under the control of the controller 170.

The vehicle driving device 600 is a device that electrically controls driving of each device in the vehicle 100.

The vehicle driving device 600 may include a powertrain driving unit 610, a chassis driving unit 620, a door/window driving unit 630, a safety apparatus driving unit 640, a lamp driving unit 650, and an air conditioner driving unit 660.

In some embodiments, the vehicle driving device 600 may further include components other than the components that are described herein, or may not include some of the components that are described herein.

Meanwhile, the vehicle driving device 600 may include a processor. Each unit of the vehicle driving device 600 may include a processor.

The powertrain driving unit 610 may control the operation of a powertrain device.

The powertrain driving unit 610 may include a power source driving unit 611 and a gearbox driving unit 612.

The power source driving unit 611 may control a power source of the vehicle 100.

For example, in the case in which the power source is an engine based on fossil fuel, the power source driving unit 611 may electronically control the engine. As a result, output torque of the engine may be controlled. The power source driving unit 611 may adjust the output torque of the engine under the control of the controller 170.

For example, in the case in which the power source is a motor based on electric energy, the power source driving unit 611 may control the motor. The power source driving unit 611 may adjust rotational speed, torque, etc. of the motor under the control of the controller 170.

The gearbox driving unit 612 may control a gearbox.

The gearbox driving unit 612 may adjust the state of the gearbox. The gearbox driving unit 612 may adjust the state of the gearbox to drive D, reverse R, neutral N, or park P.

Meanwhile, in the case in which the power source is an engine, the gearbox driving unit 612 may adjust the engagement between gears in the state of forward movement D.

The chassis driving unit 620 may control the operation of a chassis device.

The chassis driving unit 620 may include a steering driving unit 621, a brake driving unit 622, and a suspension driving unit 623.

The steering driving unit 621 may electronically control a steering apparatus in the vehicle 100. The steering driving unit 621 may change the advancing direction of the vehicle.

The brake driving unit 622 may electronically control a brake apparatus in the vehicle 100. For example, the brake driving unit may control the operation of a brake disposed at each wheel in order to reduce the speed of the vehicle 100.

Meanwhile, the brake driving unit 622 may individually control a plurality of brakes. The brake driving unit 622 may perform control such that braking forces applied to the wheels are different from each other.

The suspension driving unit 623 may electronically control a suspension apparatus in the vehicle 100. For example, in the case in which the surface of a road is irregular, the suspension driving unit 623 may control the suspension apparatus in order to reduce vibration of the vehicle 100.

Meanwhile, the suspension driving unit 623 may individually control a plurality of suspensions.

The door/window driving unit 630 may electronically control a door apparatus or a window apparatus in the vehicle 100.

The door/window driving unit 630 may include a door driving unit 631 and a window driving unit 632.

The door driving unit 631 may control the door apparatus. The door driving unit 631 may control opening or closing of a plurality of doors included in the vehicle 100. The door driving unit 631 may control opening or closing of a trunk or a tail gate. The door driving unit 631 may control opening or closing of a sunroof.

The window driving unit 632 may electronically control the window apparatus. The window driving unit may control opening or closing of a plurality of windows included in the vehicle 100.

The safety apparatus driving unit 640 may electronically control various safety apparatuses in the vehicle 100.

The safety apparatus driving unit 640 may include an airbag driving unit 641, a seatbelt driving unit 642, and a pedestrian protection apparatus driving unit 643.

The airbag driving unit 641 may electronically control an airbag apparatus in the vehicle 100. For example, when danger is sensed, the airbag driving unit 641 may perform control such that an airbag is inflated.

The seatbelt driving unit 642 may electronically control a seatbelt apparatus in the vehicle 100.

For example, when danger is sensed, the seatbelt driving unit 642 may perform control such that passengers are fixed to the 110FL, 110FR, 110RL, and 110RR using seatbelts.

The pedestrian protection apparatus driving unit 643 may electronically control a hood lift and a pedestrian airbag. For example, when collision with a pedestrian is sensed, the pedestrian protection apparatus driving unit 643 may perform control such that the hood lift is raised and the pedestrian airbag is inflated.

The lamp driving unit 650 may electronically control various lamp apparatuses in the vehicle 100.

The air conditioner driving unit 660 may electronically control an air conditioner in the vehicle 100. For example, in the case in which the temperature in the vehicle is high, the air conditioner driving unit 660 may perform control such that the air conditioner is operated to supply cold air into the vehicle.

The vehicle driving device 600 may include a processor. Each unit of the vehicle driving device 600 may include a processor.

The vehicle driving device 600 may be operated under the control of the controller 170.

The operation system 700 is a system that controls various operations of the vehicle 100. The operation system 700 may be operated in the autonomous mode. The operation system 700 may perform autonomous traveling of the vehicle 100 based on the position information of the vehicle 100 and the navigation information. The operation system 700 may include a traveling system 710, an exiting system 740, or a parking system 750.

In some embodiments, the operation system 700 may further include components other than the components that are described herein, or may not include some of the components that are described herein.

Meanwhile, the operation system 700 may include a processor. Each unit of the operation system 700 may include a processor.

Meanwhile, in some embodiments, the operation system 700 may be a low-level concept of the controller 170 in the case of being realized in the form of software.

Meanwhile, in some embodiments, the operation system 700 may be a concept including at least one of the user interface device 200, the object detection device 300, the communication device 400, the vehicle driving device 600, or the controller 170.

The traveling system 710 may perform control such that the vehicle 100 autonomously travels.

The traveling system 710 may provide a control signal to the vehicle driving device 600 such that the vehicle travels based on the vehicle traveling information. The vehicle driving device 600 may be operated based on the control signal provided by the traveling system 710. Consequently, the vehicle may autonomously travel.

For example, the traveling system 710 may provide a control signal to the vehicle driving device 600 based on object information provided by the object detection device 300 in order to perform traveling of the vehicle 100.

For example, the traveling system 710 may receive a signal from an external device through the communication device 400, and may provide a control signal to the vehicle driving device 600 in order to perform traveling of the vehicle 100.

The exiting system 740 may perform control such that the vehicle 100 automatically exits.

The exiting system 740 may provide a control signal to the vehicle driving device 600 based on the vehicle traveling information such that the vehicle 100 exits.

The vehicle driving device 600 may be operated based on the control signal provided by the exiting system 740. Consequently, the vehicle 100 may automatically exit.

For example, the exiting system 740 may provide a control signal to the vehicle driving device 600 based on object information provided by the object detection device 300 in order to perform exiting of the vehicle 100.

For example, the exiting system 740 may receive a signal from an external device through the communication device 400, and may provide a control signal to the vehicle driving device 600 in order to perform exiting of the vehicle 100.

The parking system 750 may perform control such that the vehicle 100 automatically parks.

The parking system 750 may provide a control signal to the vehicle driving device 600 based on the vehicle traveling information such that the vehicle parks.

The vehicle driving device 600 may be operated based on the control signal provided by the parking system 750. Consequently, the vehicle 100 may automatically park.

For example, the parking system 750 may provide a control signal to the vehicle driving device 600 based on object information provided by the object detection device 300 in order to perform parking of the vehicle 100.

For example, the parking system 750 may receive a signal from an external device through the communication device 400, and may provide a control signal to the vehicle driving device 600 in order to perform parking of the vehicle 100.

The navigation system 770 may provide navigation information. The navigation information may include at least one of map information, information about a set destination, route information, information about various objects on a road, lane information, traffic information, or information about the position of the vehicle.

The navigation system 770 may include a separate memory and a processor. The memory may store the navigation information. The processor may control the operation of the navigation system 770.

In some embodiments, the navigation system 770 may receive information from an external device through the communication device 400 in order to update pre-stored information.

In some embodiments, the navigation system 770 may be classified as a low-level component of the user interface device 200.

The sensing unit 120 may sense the state of the vehicle. The sensing unit 120 may include an orientation sensor (e.g. a yaw sensor, a roll sensor, or a pitch sensor), a collision sensor, a wheel sensor, a speed sensor, a slope sensor, a weight sensor, a heading sensor, a yaw sensor, a gyro sensor, a position module, a vehicle forward/rearward movement sensor, a battery sensor, a fuel sensor, a tire sensor, a steering wheel rotation sensor, an in-vehicle temperature sensor, an in-vehicle humidity sensor, an ultrasonic sensor, an ambient light sensor, an accelerator pedal position sensor, and a brake pedal position sensor.

The sensing unit 120 may acquire vehicle orientation information, vehicle collision information, vehicle direction information, vehicle position information (GPS information), vehicle angle information, vehicle speed information, vehicle acceleration information, vehicle tilt information, vehicle forward/rearward movement information, battery information, fuel information, tire information, vehicle lamp information, in-vehicle temperature information, in-vehicle humidity information, and a sensing signal, such as a steering wheel rotation angle, ambient light outside the vehicle, pressure applied to an accelerator pedal, and pressure applied to a brake pedal. The information acquired by the sensing unit 120 may be included in the vehicle traveling information.

In addition, the sensing unit 120 may further include an accelerator pedal sensor, a pressure sensor, an engine speed sensor, an air flow sensor (AFS), an air temperature sensor (ATS), a water temperature sensor (WTS), a throttle position sensor (TPS), a TDC sensor, and a crank angle sensor (CAS).

The interface 130 may serve as a path between the vehicle 100 and various kinds of external devices connected thereto. For example, the interface 130 may include a port connectable to a mobile terminal, and may be connected to the mobile terminal via the port. In this case, the interface 130 may exchange data with the mobile terminal.

Meanwhile, the interface 130 may serve as a path for supplying electrical energy to the mobile terminal connected thereto. In the case in which the mobile terminal is electrically connected to the interface 130, the interface 130 may provide electrical energy, supplied from the power supply unit 190, to the mobile terminal under the control of the controller 170.

The memory 140 is electrically connected to the controller 170. The memory 140 may store basic data about the units, control data necessary to control the operation of the units, and data that are input and output. In a hardware aspect, the memory 140 may be any of various storage devices, such as a ROM, a RAM, an EPROM, a flash drive, and a hard drive. The memory 140 may store various data necessary to perform the overall operation of the vehicle 100, such as a program for processing or control of the controller 170.

In some embodiments, the memory 140 may be integrated into the controller 170, or may be realized as a low-level component of the controller 170.

The power supply unit 190 may supply power necessary to operate each component under the control of the controller 170. In particular, the power supply unit 190 may receive power from a battery in the vehicle.

The controller 170 may control the overall operation of each unit in the vehicle 100. The controller 170 may be referred to as an electronic control unit (ECU).

In the case in which the vehicle 100 is in the autonomous mode, the controller 170 may perform autonomous traveling of the vehicle 100 based on information acquired through a device provided in the vehicle 100. For example, the controller 170 may control the vehicle 100 based on navigation information provided by the navigation system 770 and information provided by the object detection device 300 or the communication device 400. In the case in which the vehicle 100 is in the manual mode, the controller 170 may control the vehicle 100 based on an input signal corresponding to a user command received by the driving manipulation device 500. In the case in which the vehicle 100 is in the remote control mode, the controller 170 may control the vehicle 100 based on a remote control signal received by the communication device 400.

Various processors and the controller 170 included in the vehicle 100 may be realized using at least one of application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or electrical units for performing other functions.

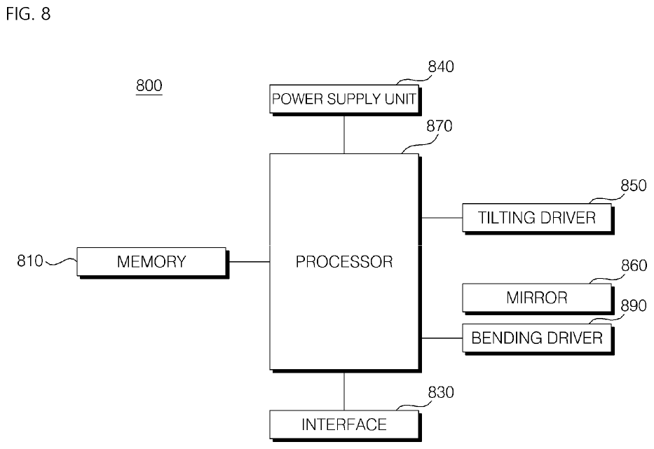

FIG. 8 is a block diagram illustrating the structure of a side mirror 800 for vehicles according to an embodiment of the present disclosure.

The side mirror 800 according to the present disclosure may include a memory 810, an interface 830, a power supply unit 840, a mirror 860, a processor 870, a tilting driver 850, and a bending driver890.

The memory 810 stores various kinds of information related to the side mirror 800.

The memory 810 may store data about each component of the side mirror 800, control data necessary to control the operation of each component, and data that are input and output.

The memory 810 is electrically connected to the processor 870. The memory 810 may provide the stored data to the processor 870. The processor 870 may store various data in the memory 810.

In some embodiments, the memory 810 may be integrated into the processor 870, or may be realized as a low-level component of the processor 870.

The memory 810 may store various data necessary to perform the overall operation of the side mirror 800, such as a program for processing or control of the processor 870.

In a hardware aspect, the memory 810 may be any of various storage devices, such as a ROM, a RAM, an EPROM, a flash drive, and a hard drive.

The interface 830 may be electrically connected to the processor 870 in order to transmit various data, transmitted from the outside, to the processor 870 or to transmit a signal or data, transmitted by the processor 870, to the outside.

The interface 830 may receive information provided by each component of the vehicle 100, and may transmit the same to the processor 870. For example, the interface 830 may acquire vehicle traveling information through at least one of the user interface 200, the object detection device 300, the communication device 400, the driving manipulation device 500, the navigation system 770, the sensing unit 120, the controller 170, or the memory 140.

The vehicle traveling information may be classified into surrounding situation information related to the situation around the vehicle 100, vehicle state information related to the state of various devices provided in the vehicle 100, and passenger information related to a passenger in the vehicle 100 depending on contents to which the information is related.

The vehicle traveling information may be classified into object information acquired by the object detection device 300, communication information that the communication device 400 receives from an external communication device, user input received by the user interface device 200 or the driving manipulation device 500, navigation information provided by the navigation system 770, various kinds of sensing information provided by the sensing unit 120, and storage information stored in the memory 140 depending on devices that provide information.

The power supply unit 840 may supply power to each component of the side mirror 800.

The power supply unit 840 may supply power necessary to operate each component under the control of the processor 870.

For example, the power supply unit 840 may receive power from a battery in the vehicle 100.

The mirror 860 may be made of a bendable material. Consequently, the mirror 860 may be bent.

The bending driver890 may bend the mirror 860.

The bending driver890 may be electrically connected to the processor 870 so as to be operated according to a control signal provided by the processor 870. Consequently, the processor 870 may control the bending driver890 such that the mirror 860 is bent.

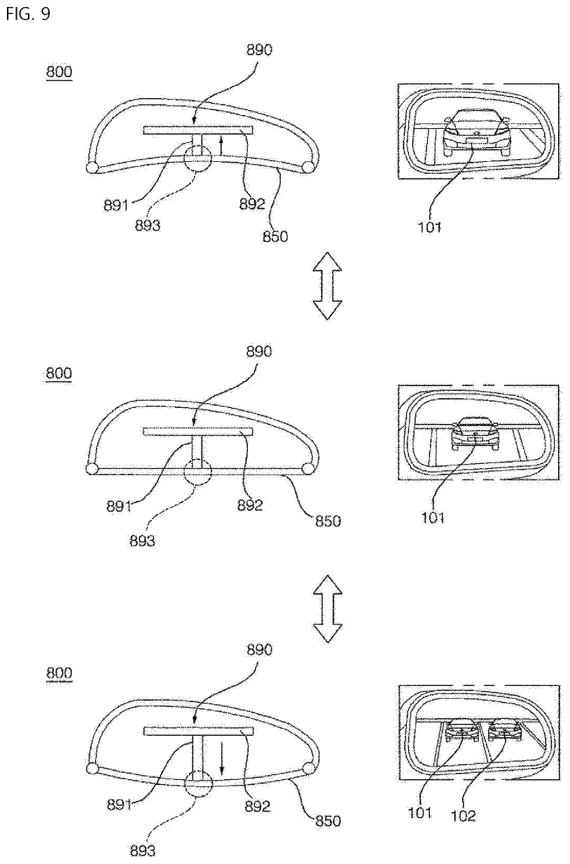

The bending driver 890 will be described in more detail with reference to FIGS. 9 to 11.

The tilting driver 850 may tilt the mirror 860 in a specific direction.

For example, the tilting driver 850 may tilt the mirror 860 upwards, downwards, leftwards, or rightwards.

The tilting driver 850 may be electrically connected to the processor 870 so as to be operated according to a control signal provided by the processor 870. Consequently, the processor 870 may control the tilting driver 850 such that the mirror 860 is tilted.

The tilting driver 850 may tilt the mirror 860, or may tilt a housing of the side mirror.

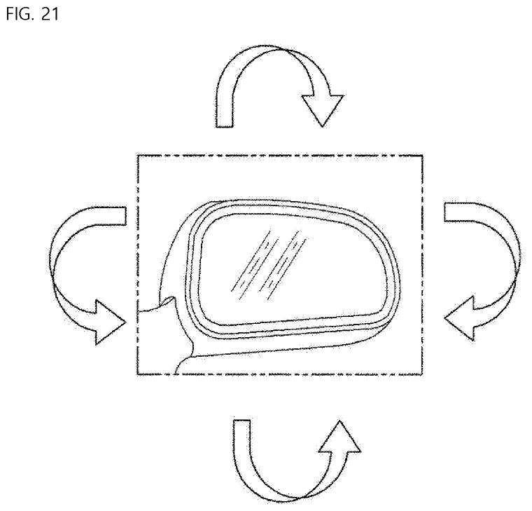

The tilting driver 850 will be described in more detail with reference to FIGS. 21 to 24.

The processor 870 may be electrically connected to each component of the side mirror 800, and may provide a control signal in order to control each component of the side mirror 800.

The processor 870 may be realized using at least one of application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or electrical units for performing other functions.

The processor 870 may bend the mirror 860 based on at least one of the surrounding situation information, the vehicle state information, or the passenger information

For example, the processor 870 may control the bending driver 890 based on the surrounding situation information in order to bend the mirror 860.

For example, the surrounding situation information may be information about an object present around the vehicle.

For example, the surrounding situation information may be information about the shape of a traveling section on which the vehicle travels.

The information about the object may be information about the position, speed, size, and kind of the object.

The information about the shape of the traveling section may include information about the shape of a road on which the vehicle travels when viewed from above, the gradient of an area in which the vehicle travels, and the kind of a road on which the vehicle travels.

The processor 870 may set a direction in which the mirror 860 is bent based on the surrounding situation information.

The direction in which the mirror 860 is bent may include a convex direction, in which the mirror 860 is convex, a concave direction, in which the mirror 860 is concave, a horizontal direction, in which the mirror 860 is bent in the leftward-rightward direction, and a vertical direction, in which the mirror 860 is bent in the upward-downward direction. Unless mentioned particularly in this specification, it is assumed that the mirror 860 is bent in the horizontal direction. The mirror 860 is bent in the vertical direction only if mentioned specifically.

A detailed description thereof will be given with reference to FIG. 9.

Upon determining that it is necessary to increase the viewing angle of the mirror 860 based on the surrounding situation information, the processor 870 may bend the mirror 860 so as to be convex.

For example, upon determining that an object is present in a blind spot of the side mirror 800 for vehicles, the traveling section is a curved section or a junction section, the vehicle 100 changes lanes, the vehicle 100 parks, the vehicle 100 deviates from the lane, or the gradient of the traveling section is a predetermined value or more based on the surrounding situation information, the processor 870 may determine that it is necessary to increase the viewing angle of the mirror 860.

For example, upon determining that user steering input is received, the vehicle 100 changes the lane, the passenger exits the vehicle based on the vehicle state information or the passenger information, the processor 870 may determine that it is necessary to increase the viewing angle of the mirror 860.

Upon determining that it is necessary to increase the viewing angle of the mirror 860, the processor 870 may bend the mirror 860 so as to be convex.

In the case in which the mirror 860 is bent so as to be convex, a reflection area on the mirror 860 may be enlarged. That the reflection area on the mirror 860 is enlarged may mean that the viewing angle of the mirror 860 is increased.

Upon determining that it is necessary to increase the viewing angle of the mirror 860, the processor 870 may determine a target viewing angle of the mirror 860 based on the surrounding situation information. The processor 870 may set the curvature of the mirror 860 based on the target viewing angle.

The target viewing angle is a viewing angle of the mirror 860 to be finally secured.

The target viewing angle of the mirror 860 is proportional to the size of an area to be reflected through the mirror 860. Consequently, the larger the area to be reflected through the mirror 860, the larger the target viewing angle of the mirror 860. In the case in which the size of the area to be reflected through the mirror 860 is increased, it is necessary to reduce the size of an image reflected on the mirror 860.

The processor 870 may determine the size of the area to be reflected through the mirror 860 (hereinafter referred to as a “first area”) based on the surrounding situation information.

The processor 870 may determine the target viewing angle of the mirror 860 based on the size of the first area.

The processor 870 may determine the viewing angle of the mirror 860 necessary for the first area to be reflected on the mirror 860 based on the position of the driver of the vehicle 100, the position of the side mirror 800, and the position and size of the first area. The viewing angle of the mirror 860 necessary for the first area to be reflected on the mirror 860 is the target viewing angle.

The processor 870 may determine the curvature of the mirror 860 corresponding to the target viewing angle. In this case, the curvature of the mirror 860 is the extent to which the mirror 860 is bent so as to be convex.

The processor 870 may bend the mirror 860 so as to be convex based on the curvature of the mirror 860 corresponding to the target viewing angle. Consequently, the driver can see the first area through the mirror 860.

Upon determining that it is necessary to increase the size of a portion of the reflection area on the mirror 860 based on the surrounding situation information, the processor 870 may bend the mirror 860 so as to be concave.

For example, upon determining that there is present an object that may collide with the vehicle 100 based on the surrounding situation information, the processor 870 may determine that it is necessary to increase the size of a portion of the reflection area on the mirror 860. In this case, the processor 870 may determine a portion of the mirror 860 on which an image of the object appears to be an area to be enlarged.

Upon determining that it is necessary to increase the size of a portion of the reflection area on the mirror 860, the processor 870 may bend the mirror 860 so as to be concave.

In the case in which the mirror 860 is bent so as to be concave, the size of the reflection area on the mirror 860 may be decreased. The smaller the reflection area on the mirror 860, the larger the image that appears on the mirror 860.

Upon determining that it is necessary to increase the size of a portion of the reflection area on the mirror 860, the processor 870 may determine a target magnifying power of an area to be enlarged based on the surrounding situation information. The processor 870 may set the curvature of the mirror 860 based on the target magnifying power.

The target magnifying power is an enlarged magnifying power of the mirror 860 to be finally secured.

The target magnifying power of the mirror 860 is inversely proportional to the size of an image of the mirror 860 on an area determined to be enlarged (hereinafter referred to as a “second area”). The image of the mirror 860 on the second area is an image of the second area reflected on the mirror 860.

Consequently, the smaller the size of image of the mirror 860 on the second area, the larger the target magnifying power of the mirror 860. The reason for this is that, in the case in which the size of the area to be enlarged, reflected on the mirror 860, is decreased, it is necessary to increase the size of an image reflected on the mirror 860.

The processor 870 may determine the size of the image of the mirror 860 on the second area based on the position of the driver of the vehicle 100, the position of the side mirror 800, and the position of the second area.

The processor 870 may determine the target magnifying power of the mirror 860 based on the size of the image of the mirror 860 on the second area.

For example, the target magnifying power may be a value corresponding to the total size of the mirror 860 relative to the size of the image of the mirror 860 on the second area.

The processor 870 may determine the curvature of the mirror 860 corresponding to the target magnifying power. In this case, the curvature of the mirror 860 is the extent to which the mirror 860 is bent so as to be concave.

The processor 870 may bend the mirror 860 so as to be concave based on the curvature of the mirror 860 corresponding to the target magnifying power. Consequently, the driver can see the enlarged second area through the mirror 860.

The processor 870 may bend the mirror 860 based on an object located at the side rear of the vehicle.

For example, upon determining that an object is located in a blind spot of the side mirror 800 based on the surrounding situation information, the processor 870 may bend the mirror 860 so as to be convex.

For example, upon determining that the possibility of collision between the object and the vehicle is a predetermined value or more based on the surrounding situation information, the processor 870 may bend the mirror 860 so as to be concave.

The processor 870 may set the speed at which the mirror 860 is bent based on the relative speed between the object and the vehicle 100.

The processor 870 may set the speed at which the mirror 860 is bent in proportion to the relative speed between the object and the vehicle 100. Consequently, the speed at which the mirror 860 is bent may be proportional to the relative speed between the object and the vehicle 100.

In the case in which the speed at which the object approaches the vehicle 100 is increased, the processor 870 may rapidly bend the mirror 860. In the case in which the speed at which the object approaches the vehicle 100 is decreased, the processor 870 may slowly bend the mirror 860.

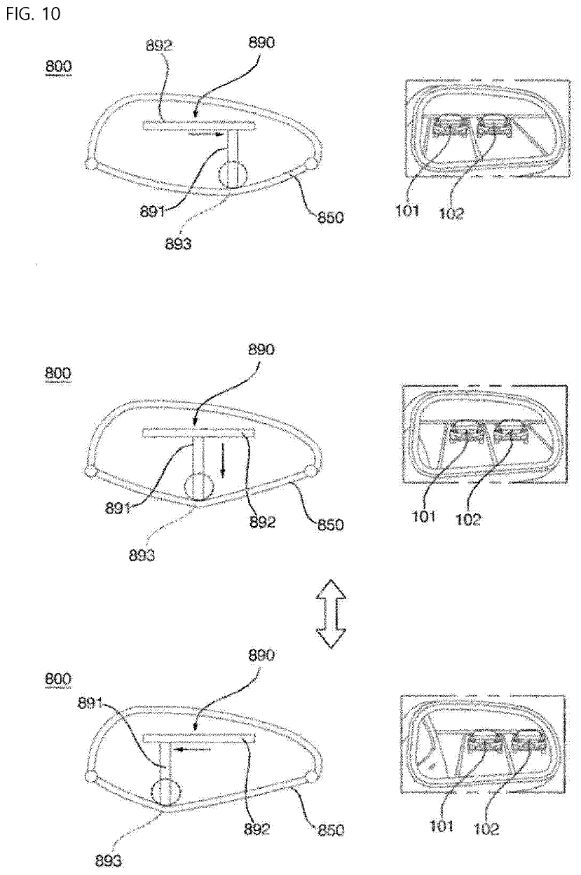

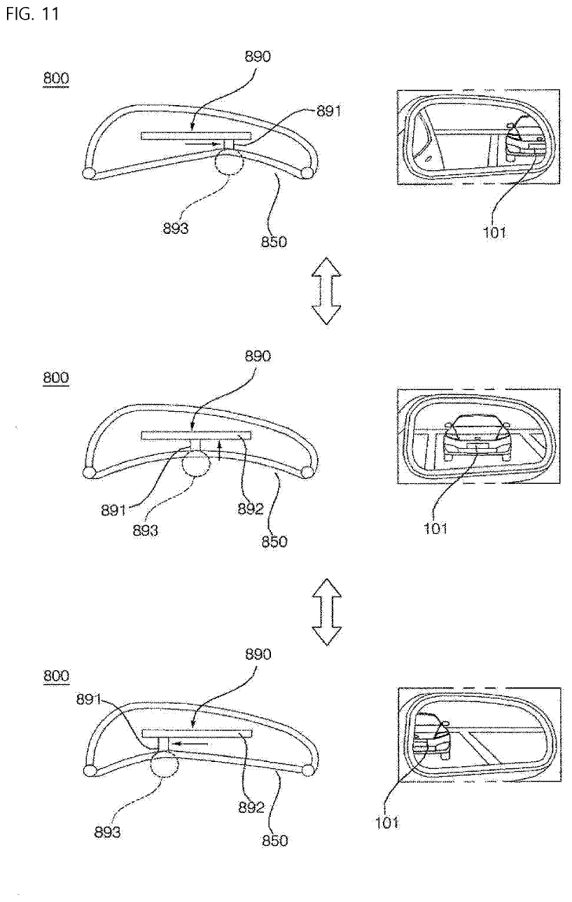

The processor 870 may set the bending point of the mirror 860 based on the position of the object. A detailed description thereof will be given with reference to FIGS. 10 and 11.

Upon determining that the object is located in the blind spot of the side mirror 800, the processor 870 may bent the mirror 860 so as to be convex such that the object is reflected on the mirror 860.

The processor 870 may determine the target viewing angle of the mirror 860 necessary to reflect the object located in the blind spot based on the position of the object.

The processor 870 may determine the curvature of the mirror 860 corresponding to the determined target viewing angle.

The processor 870 may bend the mirror 860 so as to be convex based on the determined curvature. In the case in which the mirror 860 is bent so as to be convex, the viewing angle of the mirror 860 is increased, whereby a larger area is reflected on the mirror 860.

The driver can see the object located in the blind spot through the mirror 860 that is bent so as to be convex.

Upon determining that the possibility of collision between the object and the vehicle is a predetermined reference possibility or higher based further on the vehicle state information, the processor 870 may bend the mirror 860 so as to be concave such that an area in which collision is expected is reflected on the mirror 860 in the state of being enlarged.

The processor 870 may determine the possibility of collision between the vehicle 100 and an object located around the vehicle 100 based on the surrounding situation information and the vehicle state information.

The processor 870 may compare the possibility of collision between the object and the vehicle 100 with the predetermined reference possibility.

The reference possibility is a reference value used to determine whether the object and the vehicle 100 may collide with each other. Upon determining that the possibility of collision between the object and the vehicle 100 is the reference possibility or higher, the processor 870 determines that the object and the vehicle 100 may collide with each other. The reference possibility is a value stored in the memory 810.

Upon determining that the possibility of collision between the object and the vehicle 100 is the reference possibility or higher, the processor 870 may determine an area in which collision is expected (hereinafter referred to as an “expected collision area”).

The processor 870 may determine the target magnifying power based on the size of the expected collision area reflected on the mirror 860.

The processor 870 may determine the curvature of the mirror 860 corresponding to the target magnifying power.

The processor 870 may bend the mirror 860 so as to be concave based on the determined curvature. In the case in which the mirror 860 is bent so as to be concave, the viewing angle of the mirror 860 is decreased, whereby a smaller area is reflected on the mirror 860. The smaller the area reflected on the mirror 860, the larger the size of the image that appears on the mirror 860.

The driver can see the enlarged expected collision area through the mirror 860 that is bent so as to be concave.

The interface 830 may receive steering input acquired through the steering input device 510.

The steering input may include information about the steering angle of the vehicle 100.

The processor 870 may bend the mirror 860 based on the steering input.

The processor 870 may determine the steering angle of the vehicle 100 based on the steering input. The processor 870 may bend the mirror 860 of one of a right side mirror 800R and a left side mirror 800 of the vehicle that corresponds to the direction of the steering angle of the vehicle 100 so as to be convex.

For example, upon determining that the steering angle of the vehicle 100 is tilted to the right based on the steering input, the processor 870 may bend the mirror 860 of the right side mirror 800R of the vehicle 100 so as to be convex.

For example, upon determining that the steering angle of the vehicle 100 is tilted to the left based on the steering input, the processor 870 may bend the mirror 860 of the left side mirror 800 of the vehicle 100 so as to be convex.

The processor 870 may control the bending driver890 such that the curvature of the mirror 860 that is bent is proportional to the size of the steering angle of the vehicle.

In the case in which the steering angle of the vehicle 100 is increased, therefore, the extent to which the mirror 860 of the left side mirror 800 disposed in the direction of the steering angle is bent so as to be convex is increased.

The processor 870 may set the speed at which the mirror 860 is bent based on the speed at which the steering of the vehicle is changed.

The processor 870 may set the speed at which the mirror 860 is bent in proportion to the speed at which the steering of the vehicle is changed.

Consequently, the speed at which the mirror 860 is bent so as to be convex and the speed at which the steering of the vehicle is changed are proportional to each other.

The processor 870 may determine the shape of a traveling section on which the vehicle travels based on the surrounding situation information.

The shape of the traveling section is a concept including the shape of a road when viewed from above or the gradient of a landform.

In the case in which a curved road is present within a predetermined distance from the vehicle 100 based on the surrounding situation information, the processor 870 may determine the traveling section to be a curved section.

In the case in which one of an intersection, a branch point, and a junction point is present within a predetermined distance from the vehicle 100 based on the surrounding situation information, the processor 870 may determine the traveling section to be a junction section.

The processor 870 may determine whether the section on which the vehicle 100 travels is an upward slope or a downward slope having a gradient based on the surrounding situation information.

The processor 870 may bend the mirror 860 based on the shape of the traveling section.

Upon determining that the traveling section is determined to be a junction section, the processor 870 may bend the mirror 860 of one of the right side mirror 800R and the left side mirror 800 that corresponds to the position of the junction point in the junction section so as to be convex.

For example, in the case in which the junction point is present on the right side of the vehicle 100 based on the surrounding situation information, the processor 870 may bend the mirror 860 of the right side mirror 800R of the vehicle 100 so as to be convex.

The processor 870 may control the bending driver890 such that the curvature of the bent mirror 860 is proportional to an angle between the direction of a first lane in which the vehicle travels and the direction of a second lane that the first lane joins (hereinafter referred to as a “junction angle”).

The direction of the first or second lane is the direction in which the vehicle moves in the first or second lane.

The processor 870 may determine the junction angle based on the surrounding situation information.

The processor 870 may set the curvature of the mirror 860 in proportion to the junction angle. The processor 870 may bend the mirror 860 so as to be convex based on the set curvature.

Consequently, the larger the junction angle, the larger the curvature of the mirror 860.

Upon determining that the traveling section is a curved section, the processor 870 may bend the mirror 860 of one of the right side mirror 800R and the left side mirror 800 that corresponds to the direction of the curved section so as to be convex. The direction of the curved section is the direction in which the lane is curved.

The processor 870 may control the bending driver890 such that the curvature of the bent mirror 860 is proportional to the curvature of the curved section.

Upon determining that the traveling section is a slope section, the processor 870 may bend the mirror 860 of each of the right side mirror 800R and the left side mirror 800 so as to be convex in the vertical direction.

Consequently, an area that is larger in the vertical direction is reflected on the mirror 860.

Upon determining that a predetermined event occurs based further on the vehicle state information, the processor 870 may bend the mirror 860.

The predetermined event may be the vehicle 100 changing lanes, the vehicle 100 parking, the passenger exiting the vehicle, the vehicle 100 entering a narrow curbstone section, or the vehicle 100 deviating from the lane.

The processor 870 may set the direction in which the mirror 860 is bent based on the kind of the event that occurs.

Upon determining that the vehicle 100 parks, the processor 870 may bend the mirror 860 so as to be convex. Upon determining that the vehicle 100 arrives at a predetermined destination, the user commands an automatic parking mode or a parking support mode, the processor 870 may determine that the vehicle 100 parks.

Upon determining that the vehicle 100 searches for a parking space, the processor 870 may bend the mirror 860 so as to be convex in the horizontal direction. Consequently, the driver can see a space that is wide in the leftward-rightward direction through the side mirror 80.

Upon determining that the vehicle 100 enters the parking space, the processor 870 may bend the mirror 860 so as to be convex in the vertical direction such that a parking line of the parking space is reflected on the mirror 860.

Upon determining that the passenger exits the vehicle, the processor 870 may bend the mirror 860 so as to be convex.

The processor 870 may determine whether the passenger exits the vehicle based on the passenger information.

Upon determining that another vehicle approaches the position at which the passenger is expected to exit the vehicle based on the surrounding situation information, the processor 870 may bend the mirror 860 so as to be concave such that the approaching vehicle is reflected on the mirror 860 in the state of being enlarged.

Upon determining that the vehicle 100 enters a narrow curbstone section, the processor 870 may bend the mirror 860 so as to be convex in the vertical direction such that the tire of the vehicle 100 and the curbstone are reflected on the mirror 860. The curbstone section is a lane constituted by curbstones.

Upon determining that the vehicle 100 deviates from the lane, the processor 870 may bend the mirror 860 so as to be convex in the vertical direction such that the line of the lane in which the vehicle 100 travels is reflected on the mirror 860.

Upon determining that the vehicle 100 travels in the lane in the state of being biased to one side of the lane, the processor 870 may bend the mirror 860 of one of the left side mirror and the right side mirror 800R that corresponds to the direction in which the vehicle 100 is biased so as to be convex in the vertical direction.

The predetermined event may be the vehicle changing lanes.

Upon determining that the vehicle changes lanes based on the surrounding situation information and the vehicle state information, the processor 870 may bend the mirror 860 of one of the right side mirror 800R and the left side mirror that corresponds to the direction in which the vehicle 100 moves so as to be convex.

For example, in the case in which the turn signal lamp of the vehicle 100 is turned on, the processor 870 may determine that the vehicle changes lanes.

For example, upon determining that it is necessary for the vehicle to change lanes based on an expected route of the vehicle 100, the processor 870 may determine that the vehicle 100 moves to a lane corresponding to the expected route.

FIGS. 9 to 11 are views illustrating a mode in which the mirror 860 of the side mirror 800 for vehicles according to the embodiment of the present disclosure is bent.

Referring to the figures, the bending driver890 may include a protrusion 891 connected to the mirror 860 for bending the mirror 860 and an actuator 892 for moving the protrusion 891.

The protrusion 891 and the actuator 892 are physically connected to each other.

The protrusion 891 may have a bar shape.

One side of the protrusion 891 is physically connected to the mirror 860.

A rail (not shown) may be provided on the rear surface of the mirror 860, and one side of the protrusion 891 may be coupled to the rail provided on the rear surface of the mirror 860.

When the protrusion 891 is moved upwards, downwards, leftwards, and rightwards, therefore, the connection between the mirror 860 and the protrusion 891 may be maintained.

The actuator 892 may move the protrusion 891 upwards, downwards, leftwards, and rightwards. In addition, the actuator 892 may move the protrusion 891 in the forward-rearward direction.

The actuator 892 may include a motor and a gear (not shown) for moving the protrusion 891.

The processor 870 may control the actuator 892 such that the protrusion 891 is moved forwards in order to bend the mirror 860 so as to be convex.

The processor 870 may control the actuator 892 such that the protrusion 891 is moved rearwards in order to bend the mirror 860 so as to be concave.

The processor 870 may set the direction in which the mirror 860 is bent based on the surrounding situation information.

The direction in which the mirror 860 is bent may include a convex direction, in which the mirror 860 is convex, a concave direction, in which the mirror 860 is concave, a horizontal direction, in which the mirror 860 is bent in the leftward-rightward direction, and a vertical direction, in which the mirror 860 is bent in the upward-downward direction.

In the case in which the mirror 860 is bent so as to be convex, the reflection area on the mirror 860 may be enlarged. In the case in which the reflection area on the mirror 860 is enlarged, the driver can see a large area through the mirror 860.

Referring to FIG. 9, in the case in which the mirror 860 is not bent, only a fist vehicle 101 is reflected on the mirror 860. In the case in which the mirror 860 is bent, however, the reflection area on the mirror 860 may be enlarged, whereby the first vehicle 101 and a second vehicle 102 may be reflected on the mirror 860.

In the case in which the mirror 860 is bent so as to be concave, the reflection area on the mirror 860 may be reduced. In the case in which the reflection area on the mirror 860 is reduced, the driver can see an enlarged image through the mirror 860.

Referring to FIG. 9, it can be seen that the first vehicle 101 reflected on the mirror 860 in the case in which the mirror 860 is bent so as to be concave is larger than the first vehicle 101 reflected on the mirror 860 in the case in which the mirror 860 is not bent.

Referring to FIGS. 10 and 11, the processor 870 may adjust the bending point of the mirror 860.

The bending point may be a point at which the mirror 860 is bent.

For example, the bending point may be a point at which the curvature of the mirror 860 is the maximum.

For example, the bending point may be formed at a connection point 893 at which the protrusion 891 and the mirror 860 are connected to each other.

Referring to FIG. 10, in the case in which the mirror 860 is bent so as to be convex, the processor 870 may move the protrusion 891 leftwards or rightwards in order to move the bending point of the mirror 860 leftwards or rightwards.

In the case in which the mirror 860 is bent so as to be convex, the processor 870 may move the protrusion 891 leftwards in order to move the bending point of the mirror 860 leftwards.

In the case in which the mirror 860 is bent so as to be convex, the reflection area on the mirror 860 is moved leftwards when the bending point of the mirror 860 is moved leftwards.

In the case in which the mirror 860 is bent so as to be convex, the reflection area on the mirror 860 when the bending point of the mirror 860 is closer to the left than to the middle is an area that is present further left than the reflection area on the mirror 860 when the bending point of the mirror 860 is located at the middle.

In the case in which the mirror 860 is bent so as to be convex, the processor 870 may move the protrusion 891 rightwards in order to move the bending point of the mirror 860 rightwards.

In the case in which the mirror 860 is bent so as to be convex, the reflection area on the mirror 860 is moved rightwards when the bending point of the mirror 860 is moved rightwards.

In the case in which the mirror 860 is bent so as to be convex, the reflection area on the mirror 860 when the bending point of the mirror 860 is closer to the right than to the middle is an area that is present further right than the reflection area on the mirror 860 when the bending point of the mirror 860 is located at the middle.

The processor 870 may set the bending point of the mirror 860 based on the position of an object.

The processor 870 may adjust the bending point of the mirror 860 such that the object is reflected on the mirror 860.

For example, in the case in which the mirror 860 is bent so as to be convex, the processor 870 may move the bending point of the mirror 860 leftwards upon determining that the object present at the side rear of the vehicle 100 is located further left than the reflection area on the mirror 860 when the bending point of the mirror 860 is located at the middle. Consequently, the object that is not reflected on the mirror 860 when the bending point of the mirror 860 is located at the middle may be reflected on the mirror 860.

For example, in the case in which the mirror 860 is bent so as to be convex, the processor 870 may move the bending point of the mirror 860 rightwards upon determining that the object present at the side rear of the vehicle 100 is located further right than the reflection area on the mirror 860 when the bending point of the mirror 860 is located at the middle. Consequently, the object that is not reflected on the mirror 860 when the bending point of the mirror 860 is located at the middle may be reflected on the mirror 860.

Referring to FIG. 11, in the case in which the mirror 860 is bent so as to be concave, the processor 870 may move the protrusion 891 leftwards or rightwards in order to move the bending point of the mirror 860 leftwards or rightwards.

In the case in which the mirror 860 is bent so as to be concave, the processor 870 may move the protrusion 891 leftwards in order to move the bending point of the mirror 860 leftwards.

In the case in which the mirror 860 is bent so as to be concave, the reflection area on the mirror 860 is moved rightwards when the bending point of the mirror 860 is moved leftwards.

In the case in which the mirror 860 is bent so as to be concave, the reflection area on the mirror 860 when the bending point of the mirror 860 is closer to the left than to the middle is an area that is present further right than the reflection area on the mirror 860 when the bending point of the mirror 860 is located at the middle.

In the case in which the mirror 860 is bent so as to be concave, the processor 870 may move the protrusion 891 rightwards in order to move the bending point of the mirror 860 rightwards.

In the case in which the mirror 860 is bent so as to be concave, the reflection area on the mirror 860 is moved leftwards when the bending point of the mirror 860 is moved rightwards.

In the case in which the mirror 860 is bent so as to be concave, the reflection area on the mirror 860 when the bending point of the mirror 860 is closer to the right than to the middle is an area that is present further left than the reflection area on the mirror 860 when the bending point of the mirror 860 is located at the middle.

The processor 870 may set the point of the mirror 860 that is bent so as to be concave based on the position of an area to be enlarged.

In the case in which the mirror 860 is bent so as to be concave, the processor 870 may adjust the bending point of the mirror 860 in order to set an area to be enlarged of an image on the mirror 860.

The processor 870 may bend the mirror 860 in the horizontal direction or in the vertical direction.

The processor 870 may fix the left and right ends of the mirror 860 and then move the protrusion 891 in the forward-rearward direction in order to bend the mirror 860 in the horizontal direction.

The processor 870 may fix the upper and lower ends of the mirror 860 and then move the protrusion 891 in the forward-rearward direction in order to bend the mirror 860 in the vertical direction.

To this end, a device (not shown) for fixing the mirror 860 may be provided at the upper, lower, left, and right ends of the mirror 860. The processor 870 may electrically control the device for fixing the mirror 860 in order to fix the upper and lower ends or the left and right ends of the mirror 860.

In the case in which the mirror 860 is bent in the horizontal direction, an image reflected on the mirror 860 may be changed in the horizontal direction.

In the case in which the mirror 860 is bent so as to be convex in the horizontal direction, an image reflected on the mirror 860 may be narrowed in the horizontal direction. In the case in which the image reflected on the mirror 860 is narrowed in the horizontal direction, the reflection area on the mirror 860 is widened in the horizontal direction, whereby the driver can see an image reduced in the horizontal direction through the mirror 860. Consequently, the area that the driver can see through the mirror 860 is widened in the horizontal direction.

In the case in which the mirror 860 is bent so as to be concave in the horizontal direction, an image reflected on the mirror 860 may be widened in the horizontal direction. In the case in which the image reflected on the mirror 860 is widened in the horizontal direction, the reflection area on the mirror 860 is narrowed in the horizontal direction, whereby the driver can see an image enlarged in the horizontal direction through the mirror 860.

In the case in which the mirror 860 is bent in the vertical direction, an image reflected on the mirror 860 may be changed in the vertical direction.

In the case in which the mirror 860 is bent so as to be convex in the vertical direction, an image reflected on the mirror 860 may be narrowed in the vertical direction. In the case in which the image reflected on the mirror 860 is narrowed in the vertical direction, the reflection area on the mirror 860 is widened in the vertical direction, whereby the driver can see a wider area in the vertical direction through the mirror 860. Consequently, the area that the driver can see through the mirror 860 is widened in the vertical direction.

In the case in which the mirror 860 is bent so as to be concave in the vertical direction, an image reflected on the mirror 860 may be widened in the vertical direction. In the case in which the image reflected on the mirror 860 is widened in the vertical direction, the reflection area on the mirror 860 is narrowed in the horizontal direction, whereby the driver can see an image enlarged in the vertical direction through the mirror 860.

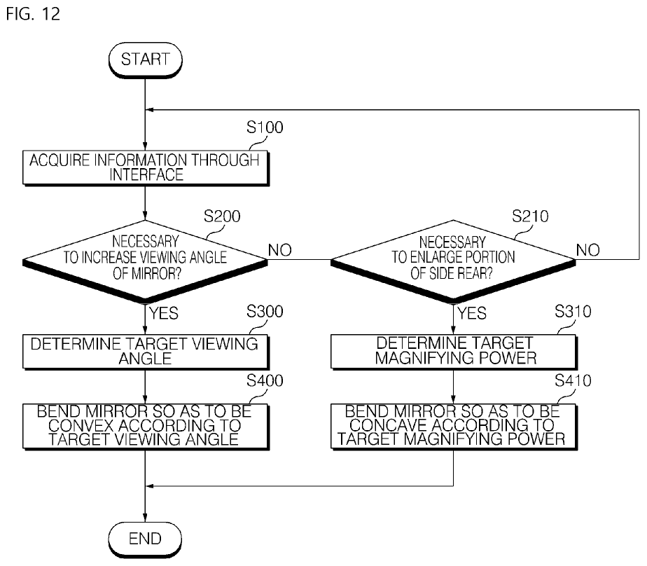

FIG. 12 is a flowchart illustrating the operation of the side mirror 800 for vehicles according to the embodiment of the present disclosure.

The processor 870 may acquire vehicle traveling information through the interface 830 (S100).

The vehicle traveling information may be classified into surrounding situation information related to the situation around the vehicle 100, vehicle state information related to the state of various devices provided in the vehicle 100, and passenger information related to a passenger in the vehicle 100 depending on contents to which the information is related.

The vehicle traveling information may be classified into object information acquired by the object detection device 300, communication information that the communication device 400 receives from an external communication device, user input received by the user interface device 200 or the driving manipulation device 500, navigation information provided by the navigation system 770, various kinds of sensing information provided by the sensing unit 120, and storage information stored in the memory 140 depending on devices that provide information.

The interface 830 may receive information provided by each component of the vehicle 100, and may transmit the same to the processor 870. For example, the interface 830 may acquire vehicle traveling information through at least one of the user interface 200, the object detection device 300, the communication device 400, the driving manipulation device 500, the navigation system 770, the sensing unit 120, the controller 170, or the memory 140.

The processor 870 may determine whether it is necessary to increase the viewing angle of the mirror 860 based on the vehicle traveling information (S200).

For example, upon determining that an object is present in a blind spot of the side mirror 800 for vehicles, the traveling section is a curved section or a junction section, the vehicle 100 changes lanes, the vehicle 100 parks, the vehicle 100 deviates from the lane, or the gradient of the traveling section is a predetermined value or more based on the surrounding situation information, the processor 870 may determine that it is necessary to increase the viewing angle of the mirror 860.

For example, upon determining that user steering input is received, the vehicle 100 changes lanes, and the passenger exits the vehicle based on the vehicle state information or the passenger information, the processor 870 may determine that it is necessary to increase the viewing angle of the mirror 860.

Upon determining that it is necessary to increase the viewing angle of the mirror 860, the processor 870 may determine a target viewing angle of the mirror 860 based on the surrounding situation information (S300).

The target viewing angle is a viewing angle of the mirror 860 to be finally secured.

The target viewing angle of the mirror 860 is proportional to the size of an area to be reflected through the mirror 860. Consequently, the larger the area to be reflected through the mirror 860, the larger the target viewing angle of the mirror 860. In the case in which the size of the area to be reflected through the mirror 860 is increased, it is necessary to reduce the size of an image reflected on the mirror 860.

The processor 870 may determine the size of the area to be reflected through the mirror 860 (hereinafter referred to as a “first area”) based on the surrounding situation information.

The processor 870 may determine the target viewing angle of the mirror 860 based on the size of the first area.

The processor 870 may determine the viewing angle of the mirror 860 necessary for the first area to be reflected on the mirror 860 based on the position of the driver of the vehicle 100, the position of the side mirror 800, and the position and size of the first area. The viewing angle of the mirror 860 necessary for the first area to be reflected on the mirror 860 is the target viewing angle.

The processor 870 may bend the mirror 860 so as to be convex according to the target viewing angle (S400).

The processor 870 may determine the curvature of the mirror 860 corresponding to the target viewing angle. In this case, the curvature of the mirror 860 is the extent to which the mirror 860 is bent so as to be convex.

The processor 870 may bend the mirror 860 so as to be convex based on the curvature of the mirror 860 corresponding to the target viewing angle. Consequently, the driver can see the first area through the mirror 860.

Upon determining that it is not necessary to increase the viewing angle of the mirror 860, the processor 870 may determine whether it is necessary to enlarge a portion of the side rear of the vehicle 100 reflected on the mirror 860 based on the vehicle traveling information (S210).

For example, upon determining that there is present an object that may collide with the vehicle 100 based on the surrounding situation information, the processor 870 may determine that it is necessary to increase the size of a portion of the reflection area on the mirror 860. In this case, the processor 870 may determine a portion of the mirror 860 on which an image of the object appears to be an area to be enlarged.

Upon determining that it is necessary to increase the size of a portion of the reflection area on the mirror 860, the processor 870 may determine a target magnifying power of an area to be enlarged based on the surrounding situation information (S310).

The target magnifying power is an enlarged magnifying power of the mirror 860 to be finally secured.

The target magnifying power of the mirror 860 is inversely proportional to the size of an image of the mirror 860 on an area determined to be enlarged (hereinafter referred to as a “second area”). The image of the mirror 860 on the second area is an image of the second area reflected on the mirror 860.

Consequently, the smaller the size of image of the mirror 860 on the second area, the larger the target magnifying power of the mirror 860. The reason for this is that, in the case in which the size of the area to be enlarged, reflected on the mirror 860, is decreased, it is necessary to increase the size of an image reflected on the mirror 860.

The processor 870 may determine the size of the image of the mirror 860 on the second area based on the position of the driver of the vehicle 100, the position of the side mirror 800, and the position of the second area.

The processor 870 may determine the target magnifying power of the mirror 860 based on the size of the image of the mirror 860 on the second area.

For example, the target magnifying power may be a value corresponding to the total size of the mirror 860 relative to the size of the image of the mirror 860 on the second area.

The processor 870 may bend the mirror 860 so as to be concave according to the target magnifying power (S410).

The processor 870 may determine the curvature of the mirror 860 corresponding to the target magnifying power. In this case, the curvature of the mirror 860 is the extent to which the mirror 860 is bent so as to be concave.

The processor 870 may bend the mirror 860 so as to be concave based on the curvature of the mirror 860 corresponding to the target magnifying power. Consequently, the driver can see the enlarged second area through the mirror 860.

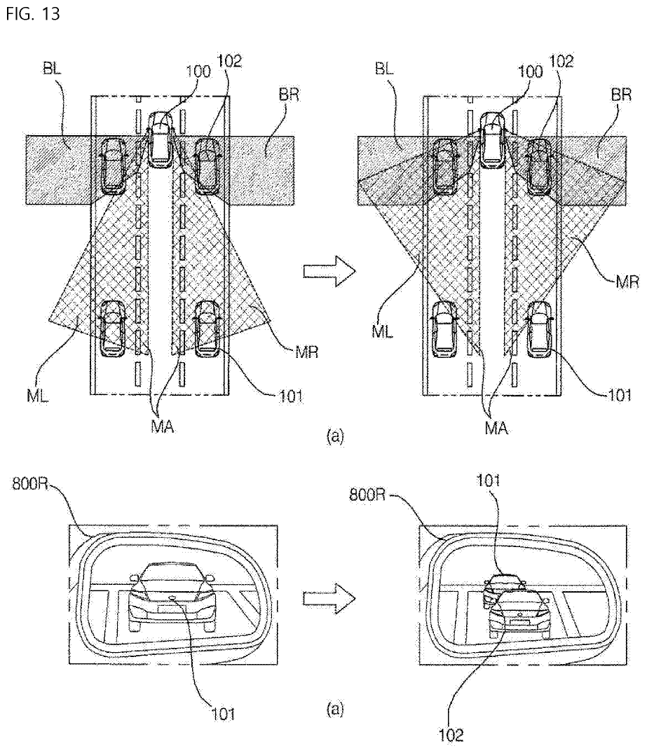

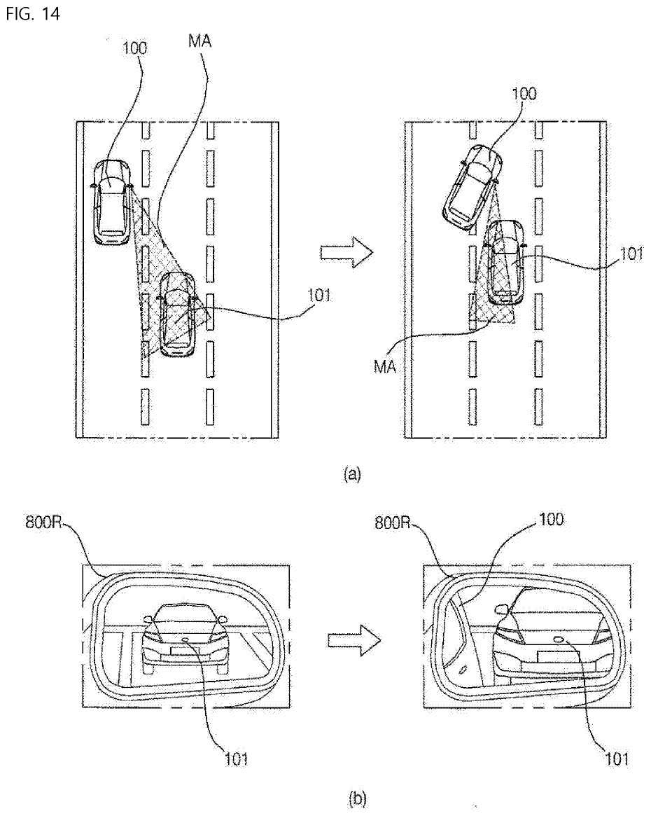

FIGS. 13 and 14 are views illustrating that the mirror 860 of the side mirror 800 for vehicles according to the embodiment of the present disclosure is bent based on an object.

Referring to FIG. 13, upon determining that another vehicle 102 is present in a blind spot BL or BR, the processor 870 may bend the mirror 860 so as to be convex.

The blind spot BL or BR is an area that the driver cannot see through the mirror 860 in the case in which the mirror 860 of the side mirror 800 provided in the vehicle is not bent.

The blind spots BL and BR include a left blind spot BL, which is present on the left side of the vehicle 100, and a right blind spot BR, which is present on the right side of the vehicle 100.

In the case in which the mirror 860 is not bent, an area MA that the driver cannot see through the mirror 860 (hereinafter referred to as a “visual field of the mirror 860”) does not include blind spots BL and BR.

The visual field MA of the mirror 860 includes a visual field ML of a left mirror 860, which is present on the left side of the vehicle 100, and a visual field MR of a right mirror 860, which is present on the right side of the vehicle 100.

In the embodiment of FIG. 13, it is assumed that a first other vehicle 101 is present in the visual field MR of the right mirror 860 and that a second other vehicle 102 is present in the right blind spot BR.

In the case in which the mirror 860 is not bent, the visual field MR of the right mirror 860 does not include the right blind spot BR, whereby the driver can see only the first other vehicle 101 through the mirror 860 of the right side mirror 800R.

The processor 870 may determine that the second other vehicle 102 is present in the right blind spot BR based on the surrounding situation information.

Upon determining that the second other vehicle 102 is present in the right blind spot BR, the processor 870 may determine that it is necessary to increase the viewing angle of the right side mirror 800R.

Upon determining that it is necessary to increase the viewing angle of the right side mirror 800R, the processor 870 may bend the mirror 860 of the right side mirror 800R so as to be convex.

The processor 870 may determine a target viewing angle of the right side mirror 800R based on the position of second other vehicle 102 present in the right blind spot BR.

The processor 870 may set the curvature of the mirror 860 of the right side mirror 800R based on the target viewing angle of the right side mirror 800R, and may bend the mirror 860 of the right side mirror 800R so as to be convex according to the set curvature.

In this case, the visual field MR of the right mirror 860 may include the second other vehicle 102 located in the right blind spot BR.

Since the first other vehicle 101 and the second other vehicle 102 are included in the visual field MR of the right mirror 860, the driver can see the first other vehicle 101 and the second other vehicle 102 through the mirror 860 of the right side mirror 800R.

Referring to FIG. 14, in the case in which an object that may collide with the vehicle 100 is present at the side rear thereof, the processor 870 may bend the mirror 860 so as to be concave such that an expected collision point is reflected on the side mirror 800 in the state of being enlarged.

The processor 870 may determine the position, expected route, and speed of another vehicle 101 traveling around the vehicle 100 based on the surrounding situation information.

The processor 870 may determine the possibility of collision between the vehicle 100 and the other vehicle 101 based on the position, expected route, and speed of the other vehicle 101 and the position, expected route, and speed of the vehicle 100.

Upon determining that the possibility of collision between the vehicle 100 and the other vehicle 101 is a predetermined reference possibility or higher, the processor 870 may bend the mirror 860 so as to be concave such that an area in which collision is expected is reflected on the mirror 860 in the state of being enlarged.

In the embodiment of the figure, as the vehicle 100 changes lanes to the left, the processor 870 may determine that the possibility of collision between the vehicle 100 and the other vehicle 101 is the reference possibility or higher.

The processor 870 may determine the right surface of the vehicle 100 to be an expected collision point based on the position, expected route, and speed of the other vehicle 101 and the position, expected route, and speed of the vehicle 100.

The processor 870 may bend the mirror 860 so as to be concave such that the right surface of the vehicle 100 that may collide with the other vehicle 101 is reflected on the mirror 860 of the right side mirror 800R in the state of being enlarged.

The processor 870 may set a bending point of the mirror 860 at which the mirror is bent so as to be concave based on the position of the expected collision point.

The processor 870 may determine a target magnifying power based on the size of an image of the expected collision point reflected on the mirror 860. The processor 870 may set the curvature of the mirror 860 at which the mirror is bent so as to be concave based on the determined target magnifying power.

Consequently, the other vehicle 101 and the right surface of the vehicle 100 may be reflected on the right side mirror 800R in the state of being enlarged.

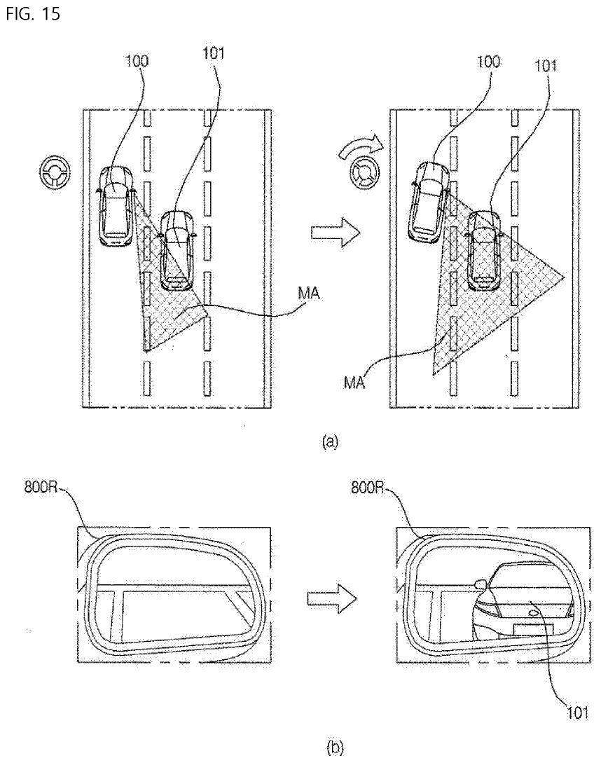

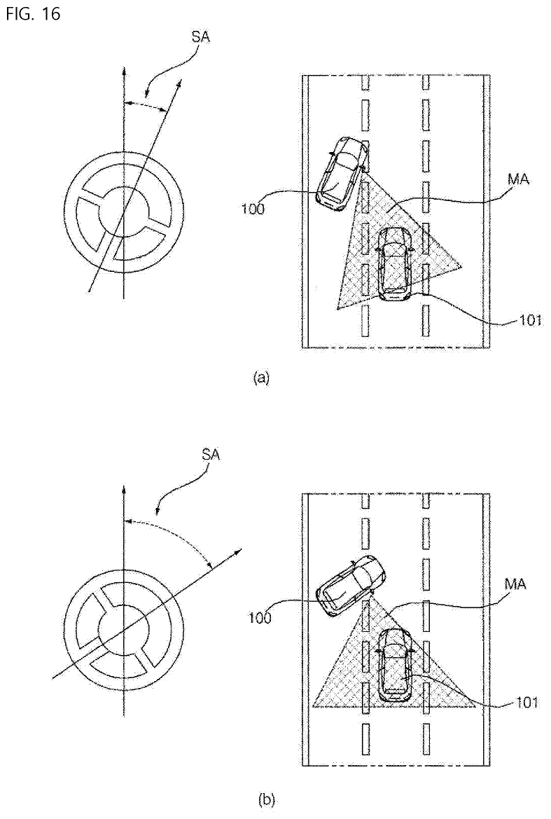

FIGS. 15 and 16 are views illustrating that the mirror 860 of the side mirror 800 for vehicles according to the embodiment of the present disclosure is bent based on vehicle steering input.

Referring to FIG. 15, the processor 870 may bend the mirror 860 of the side mirror 800 based on steering input.

The processor 870 may determine the steering angle of the vehicle based on the steering input. The processor 870 may bend the mirror 860 of one of the right side mirror 800R and the left side mirror 800 of the vehicle that corresponds to the direction of the steering angle of the vehicle so as to be convex.

Upon determining that the steering angle of the vehicle 100 is tilted to the right based on the steering input, the processor 870 may bend the mirror 860 of the right side mirror 800R of the vehicle 100 so as to be convex.

Before the mirror 860 of the right side mirror 800R is bent, the driver cannot see another vehicle 101 located on the right side of the vehicle 100 through the right side mirror 800R.

In the case in which the mirror 860 of the right side mirror 800R is bent so as to be convex, the visual field MA of the mirror 860 is increased, whereby the driver can see the other vehicle 101 located on the right side of the vehicle 100 through the right side mirror 800R.

Referring to FIG. 16, the processor 870 may control the bending driver890 such that the curvature of the mirror 860 that is bent is proportional to the size of the steering angle SA of the vehicle.

The processor 870 may determine the steering angle SA of the vehicle 100 based on the steering input.

The processor 870 may control the bending driver890 such that the steering angle SA of the vehicle 100 and the curvature of the mirror 860 that is bent so as to be convex are proportional to each other.

Consequently, the larger the steering angle SA of the vehicle 100, the larger the curvature of the mirror 860.

The larger the curvature of the mirror 860, the larger the visual field MA of the mirror 860. Consequently, the larger the steering angle SA of the vehicle 100, the larger the visual field MA of the mirror 860.

The larger the steering angle SA of the vehicle 100, the larger the target viewing angle of the mirror 860 for reflecting the other vehicle 101 beside the vehicle.

As the target viewing angle of the side mirror 800 is increased, the processor 870 increases the curvature of the mirror 860. As the curvature of the mirror 860 is increased, the visual field MA of the mirror 860 is increased.

Since the visual field MA of the mirror 860 is increased, the driver can see the other vehicle 101 through the side mirror 800 even in the case in which the steering of the vehicle 100 is changed.

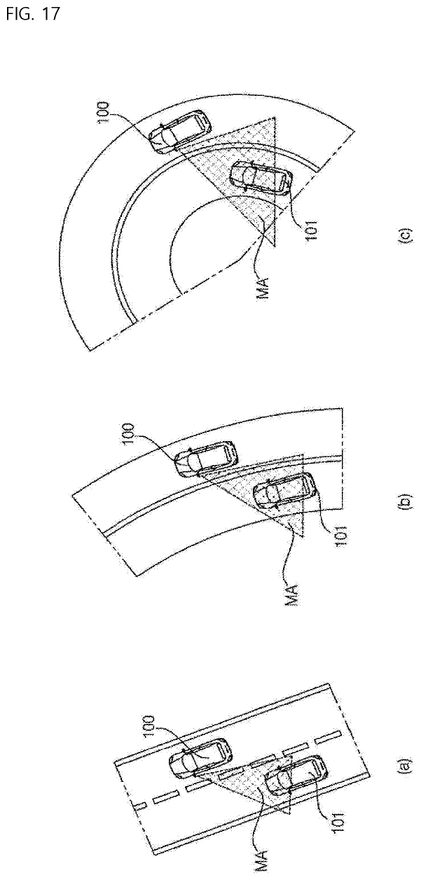

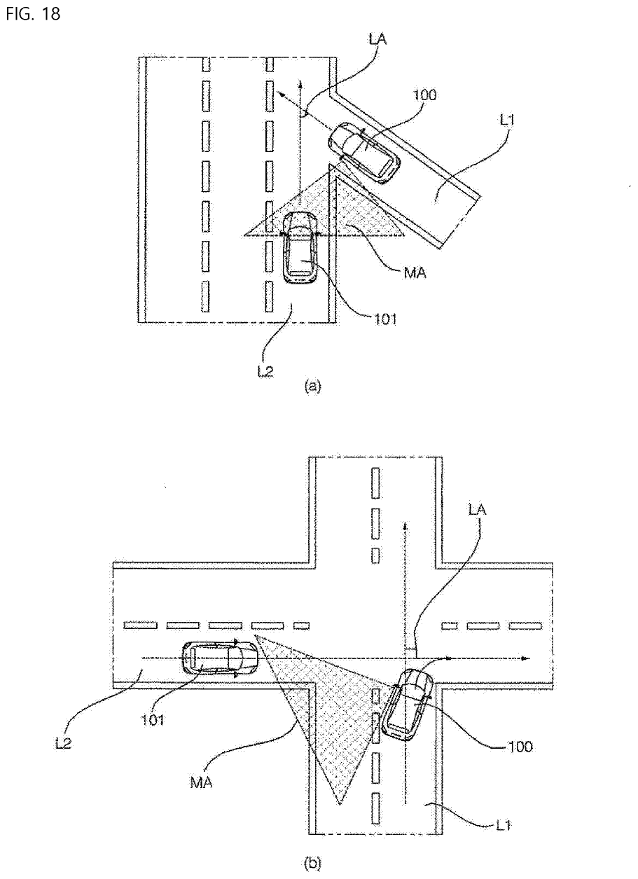

FIGS. 17 and 18 are views illustrating that the mirror 860 of the side mirror 800 for vehicles according to the embodiment of the present disclosure is bent based on the shape of a traveling section.

Referring to FIG. 17, upon determining that the traveling section is a curved section, the processor 870 may bend the mirror 860 of one of the right side mirror 800R and the left side mirror 800 that corresponds to the direction of the curved section so as to be convex.

In the embodiment of (a), the processor 870 may determine that the traveling section is a straight section based on the surrounding situation information.

Upon determining that the traveling section is a straight section, the processor 870 does not bend the mirror 860.

In the embodiments of (b) and (c), the processor 870 may determine that the traveling section is a curved section based on the surrounding situation information.

The processor 870 may control the bending driver890 such that the curvature of the curved section and the curvature of the mirror 860 are proportional to each other. As the curvature of the curved section is increased, therefore, the curvature of the mirror 860 at which the mirror is bent so as to be convex is increased, whereby the visual field MA of the mirror 860 is increased.

The driver can see another vehicle 101 located at the side rear thereof through the side mirror 800 irrespective of the curvature of the curved section.

Referring to FIG. 18, upon determining that the traveling section is a junction section, the processor 870 may bend the mirror 860 of one of the right side mirror 800R and the left side mirror 800 that corresponds to the position of a junction point in the junction section so as to be convex.

In the embodiment of (a), the processor 870 may determine that the junction section is present on the left side of the vehicle 100 based on the surrounding situation information, and may bend the mirror 860 of the left side mirror 800 of the vehicle 100 so as to be convex.

The processor 870 may determine an angle LA between the direction of a first lane L1 in which the vehicle travels and the direction of a second lane L2 that the first lane joins (hereinafter referred to as a “junction angle”) based on the surrounding situation information.

In the case in which the junction angle LA is increased, it is necessary to increase the visual field MA of the side mirror 800.

To this end, the processor 870 may control the bending driver890 such that the curvature of the mirror 860 of the left side mirror 800 is proportional to the junction angle LA. Consequently, the larger the junction angle LA, the larger the curvature of the mirror 860 at which the mirror is bent so as to be convex.

In the embodiment of (b), the processor 870 may determine that the junction section is an intersection.

Upon determining that the vehicle 100 passes through the intersection, the processor 870 may bend the mirror 860 of one of the left side mirror and the right side mirror 800R that corresponds to the position of another vehicle 101 approaching the vehicle 100 at the intersection so as to be convex.

Upon determining that the vehicle 100 turns left at the intersection and there is present another vehicle 101 approaching the vehicle 100 from the left side thereof based on the surrounding situation information and the vehicle state information, the processor 870 may bend the mirror 860 of the left side mirror 800 so as to be convex.

The processor 870 may set the curvature of the mirror 860 based on the position of the other vehicle 101 and the position and heading angle of the vehicle 100 such that the driver can see the other vehicle 101 through the side mirror 800.

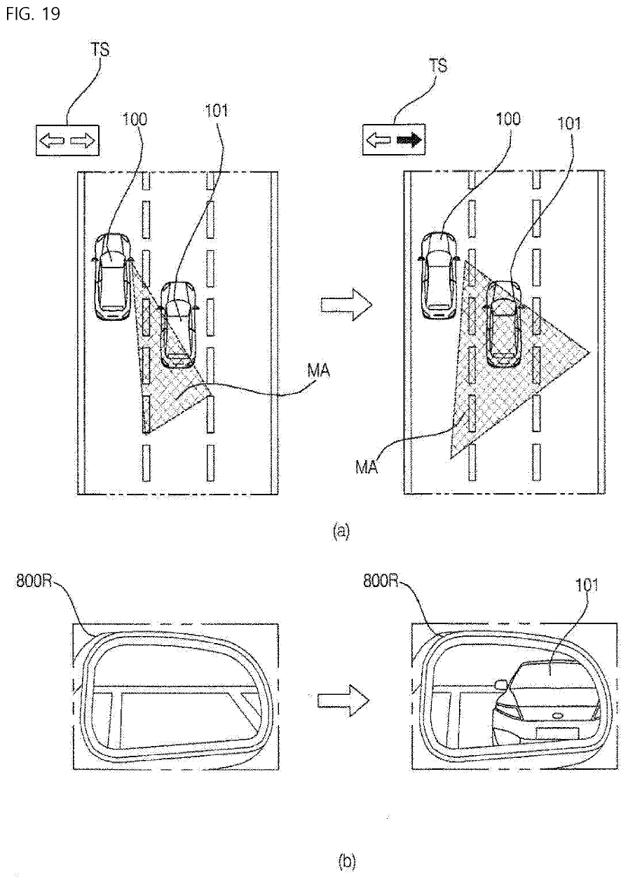

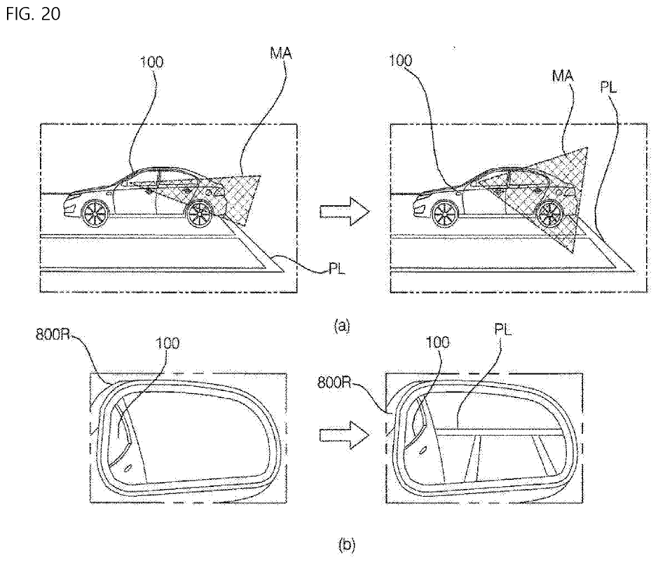

FIGS. 19 and 20 are views illustrating that the mirror 860 of the side mirror 800 for vehicles according to the embodiment of the present disclosure is bent based on a predetermined event.

Upon determining that a predetermined event occurs based on one or more of the surrounding situation information, the vehicle state information, and the passenger information, the processor 870 may bend the mirror 860 of the side mirror 800.

The predetermined event may be the vehicle 100 changing lanes, the vehicle 100 parking, the passenger exiting the vehicle, the vehicle 100 entering a narrow curbstone section, or the vehicle 100 deviating from the lane.

Information about the predetermined event may be stored in the memory 810.

In addition, the user may set an event in which the mirror 860 of the side mirror 800 is bent through the user interface device 200 provided in the vehicle 100. The processor 870 may set an event based on user input received through the user interface device 200, and may store information about the set event in the memory 810.

The processor 870 may set the direction in which the mirror 860 is bent based on the kind of an event that occurs.

Referring to FIG. 19, upon determining that the vehicle 100 changes lanes, the processor 870 may determine that a predetermined event occurs.

The processor 870 may determine whether the vehicle 100 changes lanes based on the operation state of the turn signal lamp provided in the vehicle 100.

The processor 870 may determine the operation state of the turn signal lamp based on the vehicle state information.

Upon determining that a right turn signal lamp of the vehicle 100 turns on based on the vehicle state information, the processor 870 may determine that the vehicle 100 moves to a right lane.

Upon determining that the vehicle 100 moves to the right lane, the processor 870 may bend the mirror 860 of the right side mirror 800R so as to be convex.

In this case, the processor 870 may determine the target viewing angle of the mirror 860 for the driver seeing another vehicle 101 through the mirror 860 based on the position of the other vehicle 101. The processor 870 may adjust the curvature of the mirror 860 according to the determined target viewing angle. Consequently, the driver can see the other vehicle 101 through the right side mirror 800R.

Referring to FIG. 20, upon determining that the vehicle 100 parks, the processor 870 may determine that a predetermined event occurs.

Upon determining that the vehicle 100 enters a parking space defined by a parking line PL based on the surrounding situation information, the processor 870 may determine that the vehicle 100 parks.

Upon determining that the vehicle 100 enters the parking space defined by the parking line PL, the processor 870 may bend the mirror 860 so as to be convex in the vertical direction such that the parking line PL is reflected on the mirror 860.

In the case in which the processor 870 bends the mirror 860 so as to be convex in the vertical direction, the visual field MA of the mirror 860 may be increased in the upward-downward direction. In the case in which the visual field MA of the mirror 860 is increased in the upward-downward direction, a parking line PL that is not reflected on the mirror may be reflected on the mirror.

Consequently, the driver can confirm the parking line PL through the side mirror 800 during parking.

FIGS. 21 to 24 are views illustrating that the mirror 860 of the side mirror 800 for vehicles according to the embodiment of the present disclosure is tilted based on the environment around the vehicle.

Referring to FIG. 21, the processor 870 may control the tilting driver 850 such that the mirror 860 is tilted in one of the upward direction, the downward direction, the rightward direction, and the leftward direction.

The tilting driver 850 may tilt the mirror 860 alone, or may tilt the entire housing of the side mirror 800.

In the case in which the mirror 860 is tilted in a specific direction, the reflection area on the mirror 860 is adjusted in the direction in which the mirror 860 is tilted.

For example, in the case in which the mirror 860 is tilted in the rightward direction, the reflection area on the mirror 860 is adjusted in the rightward direction. In this case, the driver can see an area that is present further rightwards through the side mirror 800.

The processor 870 may tilt the mirror 860 based on the vehicle traveling information.

Upon determining that an object or area that the driver must recognize (hereinafter referred to as a “caution object”) is present beside the vehicle 100 based on the vehicle traveling information, the processor 870 may tilt the mirror 860 such that the caution object is reflected on the mirror 860.

The caution object may be an object determined to be capable of colliding with the vehicle 100 or an object that affects the safety of the vehicle 100 (e.g. a sinkhole formed in the surface of a road or an obstacle formed on the surface of the road).

The processor 870 may determine the presence and position of a caution object based on the surrounding situation information.

Upon determining that there is present a caution object, the processor 870 may set the tilting direction and tilting degree of the mirror 860 based on the position of the caution object.

Even in the case in which the mirror 860 is bent so as to be convex in order to increase the viewing angle of the mirror 860, an object to be reflected on the mirror 860 may not be reflected on the mirror. In the side mirror 800 according to the present disclosure, in the case in which an object to be reflected on the mirror is not reflected on the mirror even when the mirror 860 is bent, the mirror 860 may be tilted such that the object is reflected on the mirror 860.

The processor 870 may determine whether the driver can see an area or an object to be reflected on the mirror 860 (hereinafter referred to as a “target”) through the mirror 860 after the mirror 860 is bent based on the position of the driver, the position of the side mirror 800, and the position of the target.

Upon determining that the driver cannot see the target through the mirror 860 even after the mirror 860 is bent, the processor 870 may tilt the mirror 860 such that the target is reflected on the mirror 860.

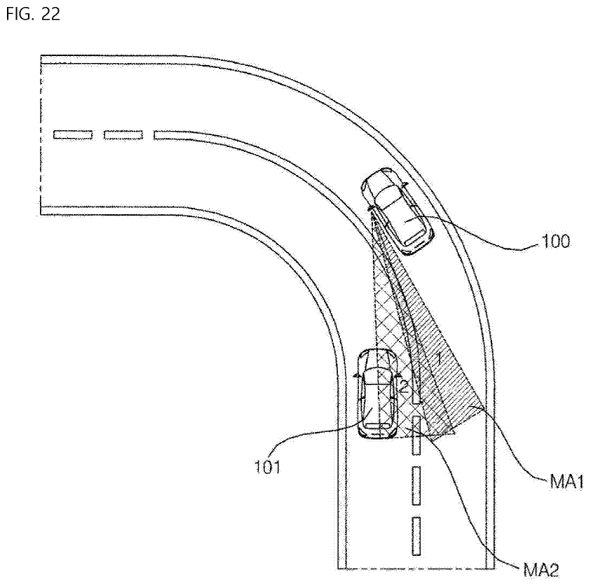

Referring to FIG. 22, the processor 870 may tilt the mirror 860 based on the shape of a traveling section.

Upon determining that the traveling section is a curved section based on the surrounding situation information, the processor 870 may tilt one of the left side mirror and the right side mirror 800R that corresponds to a curved direction of the curved section in the curved direction.

For example, upon determining that the traveling section is a curved section that is curved to the left based on the surrounding situation information, the processor 870 may tilt the left side mirror 800 to the left.

Upon determining that the traveling section is a curved section and that another vehicle 101 is located at the side rear of the vehicle 100, the processor 870 may set the tilting degree of the side mirror 800 based on the position of the other vehicle 101.

The processor 870 may set the tilting degree of the side mirror 800 such that the driver can see the other vehicle 101 through the mirror 860 of the side mirror 800.

Consequently, the visual field of the mirror 860 may be changed from a first visual field MA1 to a second visual field MA2.

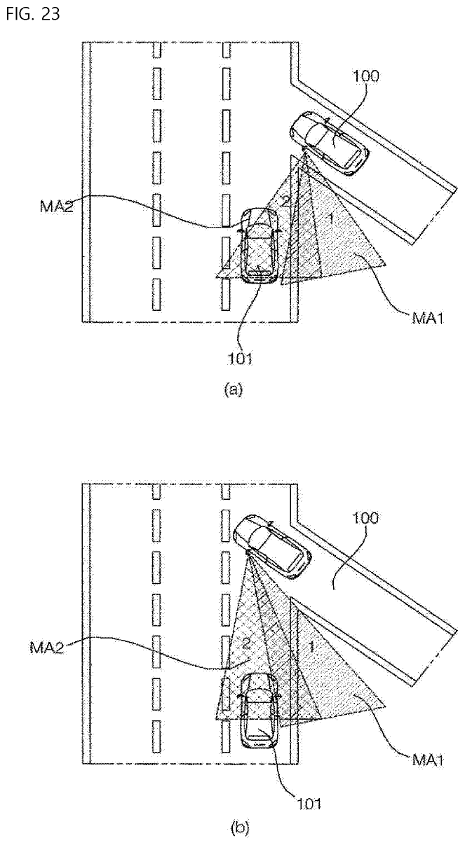

Referring to FIG. 23, upon determining that the traveling section is a junction section, the processor 870 may tilt the side mirror 800.

Upon determining that the traveling section is a junction section, the processor 870 may tilt one of the right side mirror 800R and the left side mirror 800 that corresponds to the position of a junction point in the junction section.

Upon determining that the junction point is present on the left side of the vehicle 100 based on the surrounding situation information, the processor 870 may tilt the left side mirror 800 to the left.

Upon determining that another vehicle 101 approaching the vehicle 100 is present around the junction point based on the surrounding situation information, the processor 870 may set the tilting degree of the side mirror 800 based on the position of the other vehicle 101.

The processor 870 may adjust the tilting degree of the side mirror 800 based on the position of the other vehicle 101 that is changed in real time.

In the embodiment of the figure, as the vehicle 100 enters the junction point, the relative position between the other vehicle 101 and the vehicle 100 is changed. In this case, the processor 870 may determine that the position of the other vehicle 101 is relatively changed based on the surrounding situation information. The processor 870 may change the tilting degree of the left side mirror 800 based on the position of the other vehicle 101 that is changed. Even when the vehicle 100 moves, therefore, the other vehicle 101 is located in the visual field MA2 of the tilted side mirror 800.

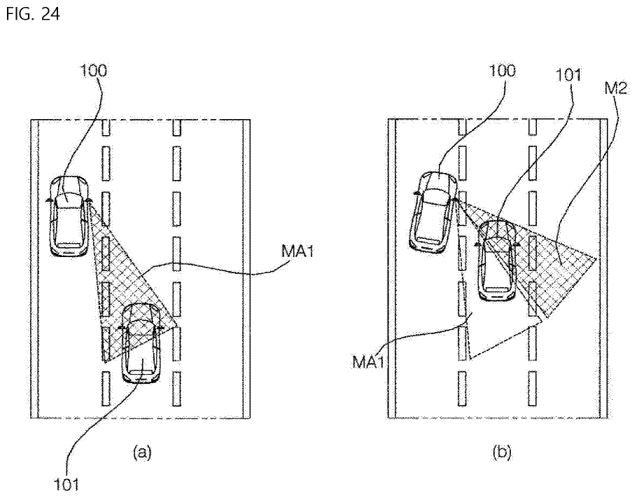

Referring to FIG. 24, the processor 870 may tilt the mirror 860 based on steering input of the vehicle 100.

The processor 870 may set the tilting direction of the mirror 860 according to the steering angle of the vehicle 100 determined based on the steering input.

Upon determining that the steering angle of the vehicle 100 is changed in the leftward direction, the processor 870 may tilt the mirror 860 of the left side mirror 800 to the left.

Upon determining that another vehicle 101 is present in the tilting direction of the mirror 860, the processor 870 may set the tilting degree of the mirror 860 based on the relative position between the vehicle and the other vehicle 101.

The driver can more accurately recognize the position of the other vehicle 101 by the visual field MA2 of the mirror 860 after tilting than the visual field MA1 of the mirror 860 before tilting.

The present disclosure as described above may be implemented as code that can be written on a computer-readable medium in which a program is recorded and thus read by a computer. The computer-readable medium includes all kinds of recording devices in which data is stored in a computer-readable manner. Examples of the computer-readable recording medium may include a hard disk drive (HDD), a solid state disk (SSD), a silicon disk drive (SDD), a read only memory (ROM), a random access memory (RAM), a compact disk read only memory (CD-ROM), a magnetic tape, a floppy disc, and an optical data storage device. In addition, the computer-readable medium may be implemented as a carrier wave (e.g. data transmission over the Internet). In addition, the computer may include a processor or a controller. Thus, the above detailed description should not be construed as being limited to the embodiments set forth herein in all terms, but should be considered by way of example. The scope of the present disclosure should be determined by the reasonable interpretation of the accompanying claims and all changes in the equivalent range of the present disclosure are intended to be included in the scope of the present disclosure.

1. A side mirror comprising:
a mirror configured to be bendable;
a bending driver configured to bend the mirror;
an interface configured to receive information about a situation around a vehicle; and
a processor configured to control the bending driver based on the surrounding situation information in order to bend the mirror.

2. The side mirror according to claim 1, wherein
the surrounding situation information is information about an object present around the vehicle or a shape of a traveling section on which the vehicle travels, and
the processor is configured to set a direction in which the mirror is bent based on the surrounding situation information.

3. The side mirror according to claim 2, wherein the processor is configured, upon determining that increase in a viewing angle of the mirror based on surrounding situation information is necessary, to bend the mirror so as to be convex.

4. The side mirror according to claim 3, wherein the processor is configured:
to determine a target viewing angle of the mirror based on surrounding situation information; and
to set a curvature of the mirror according to the target viewing angle.

5. The side mirror according to claim 2, wherein the processor is configured, upon determining that enlargement of an area reflected on the mirror based on the surrounding situation information is necessary, to bend the mirror so as to be concave.

6. The side mirror according to claim 5, wherein the processor is configured:
to determine a target magnifying power of the area to be enlarged based on the surrounding situation information; and
to set a curvature of the mirror based on the target magnifying power.

7. The side mirror according to claim 2, wherein the processor is configured to set a speed at which the mirror is bent based on a relative speed between the object and the vehicle.

8. The side mirror according to claim 2, wherein the processor is configured to set a bending point of the mirror based on a position of the object.

9. The side mirror according to claim 1, wherein the processor is configured to bend the mirror based on an object located at a side rear of the vehicle.

10. The side mirror according to claim 9, wherein the processor is configured, upon determining that the object is located in a blind spot of the side mirror, to bend the mirror so as to be convex such that the object is reflected on the mirror.

11. The side mirror according to claim 9, wherein
the interface is configured to further receive vehicle state information, and
the processor is configured, upon determining that a possibility of collision between the object and the vehicle is a predetermined reference possibility or higher based further on the vehicle state information, to bend the mirror so as to be concave such that an area in which collision is expected is reflected on the mirror in a state of being enlarged.

12. The side mirror according to claim 1, wherein
the interface is configured to receive steering input acquired through a steering input device, and
the processor is configured to bend the mirror based on the steering input.

13. The side mirror according to claim 12, wherein the processor is configured:
to determine a steering angle of the vehicle based on the steering input;
to bend the mirror of one of a right side mirror and a left side mirror of the vehicle that corresponds to a direction of the steering angle so as to be convex; and
to control the bending driver such that a curvature of the mirror that is bent is proportional to a size of the steering angle.

14. The side mirror according to claim 12, wherein the processor is configured to set a speed at which the mirror is bent based on a speed at which steering of the vehicle is changed.

15. The side mirror according to claim 1, wherein the processor is configured:
to determine a shape of a traveling section on which the vehicle travels based on the surrounding situation information; and
to bend the mirror based on the shape of the traveling section.

16. The side mirror according to claim 15, wherein the processor is configured:
upon determining that the traveling section is a junction section,
to bend the mirror of one of a right side mirror and a left side mirror that corresponds to a position of a junction point in the junction section so as to be convex, and
to control the bending driver such that a curvature of the mirror that is bent is proportional to an angle between a direction of a first lane in which the vehicle travels and a direction of a second lane that the first lane joins.

17. The side mirror according to claim 1, wherein
the interface is configured to further receive vehicle state information, and
the processor is configured:
upon determining that a predetermined event occurs based further on the vehicle state information, to bend the mirror, and
to set a direction in which the mirror is bent based on a kind of the event that occurs.

18. The side mirror according to claim 17, wherein
the event is the vehicle changing lanes, and
the processor is configured, upon determining that the vehicle changes lanes based on the surrounding situation information and the vehicle state information, to bend the mirror of one of a right side mirror and a left side mirror that corresponds to a direction in which the vehicle moves so as to be convex.

19. The side mirror according to claim 1, wherein
the bending driver comprises:
a protrusion connected to the mirror, the protrusion being configured to bend the mirror; and
an actuator configured to move the protrusion, and
the processor is configured:
to control the actuator such that the protrusion is moved forwards in order to bend the mirror so as to be convex; and
to control the actuator such that the protrusion is moved rearwards in order to bend the mirror so as to be concave.

20. A vehicle comprising the side mirror according to claim 1.
